(19) United States
(12) Patent Application Publication
(10) Pub. No.: US 2008/0010129 A1
(43) Pub. Date: Jan. 10, 2008

(54) System and method for providing access to advertisements

(76) Inventor: Frank S. Maggio, St. Petersburg, FL (US)

Correspondence Address: KING & SPALDING LLP, 1180 PEACHTREE STREET, ATLANTA, GA, 30309-3521, US

(21) Appl. No.: 11/452,887

(22) Filed: Jun. 14, 2006

(51) Int. Cl. G06Q 30/00

(52) U.S. Cl. 705/14

(57) ABSTRACT

A system and method for providing access to advertisements provides consumers with the ability to access information about products or ads from disparate sellers at a single point of access. Advertisements typically include a sound, symbol, or number that alerts consumers that information about the product or ad can be found by calling a single telephone number, for unrelated products and sellers. The consumer typically calls the telephone number and provides information they recall about the advertisement by interacting with an interactive voice response system. The memory portal system can use the information to determine the advertisement or product sought by the consumer and play or transmit the advertisement to the consumer. The memory portal system can also provide the consumer with information that was not available about the product in the advertisement and directly connect the consumer with the seller of the product over the telephone.

### FIELD OF THE INVENTION

The present invention relates to the fields of broadcast advertising and navigable voice systems accessible to a user via a telephone. In particular, the invention provides a method and system for providing a single resource to retrieve information about an advertisement over the telephone.

### BACKGROUND OF THE INVENTION

Advertising is an important and effective way for manufacturers and retailers (hereinafter “sellers”) to teach the buying public about the products or services that they offer. One of the reasons that advertising is effective is its ability to carry over into different types of media. For example, information about a particular product can be advertised on radio, television, billboards, print media, in advertisements on the Internet and even aerial banners. Advertisements typically include the name of the product that the advertiser is trying to sell, a description of the features of the product, and why a consumer in the buying public should purchase the advertised product. As more sellers make greater use of advertising as a key method of promoting their products, it becomes difficult for the average consumer to recall enough information from an advertisement to distinguish one product from another. Today, sellers can try to include additional information in their advertisements, such as statements that tell a consumer to “call now,” typically known as a call to action, or an offer of additional information, such as “for more information please go to www.moreproductinfo.com.” to make their advertisements more effective.

However, for advertising to be effectively broadcast to a consumer, the consumer will need to remember at least a portion of the advertisement. As advertisers increase the amount of information in an advertisement, they generally need a consumer to recall more about the advertisement, thereby reducing the likelihood that the consumer will be able to recall a sufficient amount of information for that advertisement to be effective. In addition, sellers have increasingly been attempting to interject advertising into all aspects of the life of a consumer. Advertisements can now be seen on pop-ups and files downloaded over the Internet, on park benches, and on supermarket carts. While new methods and places for advertising increase a consumer's exposure to advertisements, it also increases the seller's dependency on the consumer to recall the information on the advertisement.

While the seller's dependency on the recall of the consumer can be reduced if the consumer has the ability to write down the information at the time they hear or see the ad, the seller often can not rely on this. In many cases, the consumer does not keep a pen and pad at their side in order to write down information they do not want to forget. Furthermore, there are many situations where writing down information about the advertisement, while doable, is not safe or proper. For example, a consumer driving a car may encounter advertisements in many different forms, including over the radio, on billboards, and on other vehicles. However, it is often not safe or prudent for the consumer to take his or her concentration off of driving to write down information he or she wants to recall later.

Furthermore, as more sellers insert calls to action and provide methods to get additional information, it further strains the recall of the consumer and decreases the effectiveness of advertisements overall. If consumers could view or hear an advertisement and the advertisement included some method of alerting the consumer that if they want additional information about a product offered in the advertisement the consumer could call a telephone number that is easily recognizable, and further, if the same telephone number was used for a multitude of products provided by unrelated sellers across a broad spectrum of product categories it would limit the amount of information that the consumer would have to recall. Then a consumer would not have to remember the phone number or the website of the particular product. Instead they may only have to recall the product, or where and when they heard or saw the advertisement in order to receive information over the telephone about the product and the advertisement. In addition, if consumers were able to call this single telephone number irrespective of the particular seller and have the ability to hear the advertisement again at a time more convenient to the consumer and at a time where they could potentially record information provided in the advertisement, the effectiveness of the advertisement would be increased.

In view of the foregoing, there is a need in the art for a method of including in advertisements a sound, symbol, or telephone number that alerts viewers or listeners to the advertisement that information about the advertisement or the product offered in the advertisement can be accessed by calling a single telephone number. Furthermore, there is a need in the art for a system that is accessible by a single telephone number and comprises a database of advertisements, information about advertisements, and information about products and has the capability to contact and provide consumers with access to the sellers of the products. Furthermore, there is a need in the art for a method for receiving information about a product or advertisement from a consumer, determining the product or advertisement being sought by the consumer and providing the consumer with access to the advertisement or the seller of the product offered in the advertisement.

### SUMMARY OF THE INVENTION

An ad retrieval method provides a method for a single point of access to retrieve information about multiple advertisements from a multitude of unrelated sellers with each advertisement having the same reference embedded into the advertisement. A consumer can view or hear an advertisement. The advertisement can include a reference that the consumer associates with the ad retrieval system or associates with the telephone number to contact the ad retrieval system. The reference can include the phone number of the ad retrieval system, a symbol, a catch-phrase, or one or more audible tones that a consumer associates with contacting the ad retrieval system.

The reference to the ad retrieval system can be embedded in advertisements provided in television, radio, print, billboard and internet media. The ad retrieval system can receive calls into the system from a consumer, or user, of the system. The ad retrieval system can include an interactive voice response system that requests information about the advertisement from the user through one or more series of voice prompts. The information provided by the user can be stored by the ad retrieval system and used to search an ad database of the ad retrieval system for advertisements that match the information provided by the user. The ad database can include a reproduction of the advertisement, the location the ad was broadcast or displayed, the date and time of the broadcast or display, the product or service being offered in the advertisement, the type of product or service being offered in the advertisement, the seller associated with the advertisement, and keywords, including but not limited to product, company, or product benefits. A seller can be associated with the advertisement if they sell, distribute, or manufacture the product.

If a matching advertisement is found in the ad database, information about the ad can be retrieved and a reproduction of the ad can be provided to the user. The reproduction can include an audio replay of the advertisement, transmitting a graphic display of the advertisement, or the interactive voice response playing the keywords or script of the advertisement. Contact information for the seller associated with the advertisement can be retrieved and the ad retrieval system can connect the user with the seller via a telephonic connection. Additional information about the product or service associated with the advertisement can also be retrieved from the ad database and provided to a user.

For one aspect of the present invention, a method of providing a single point of access to retrieve information about multiple advertisements from a multitude of unrelated sellers is described. The method provides an advertisement that includes a reference that alerts the consuming public that information about the advertisement is available at the ad retrieval system. The advertisement can be played, displayed, or generated, depending on the medium on which the advertisement in provided. A request for information about the advertisement can be received at the ad retrieval system from a user via a telephone. The ad retrieval system can determine if it contains information about the advertisement upon which the user is requesting information. If the ad retrieval system contains information about the requested advertisement, the information can be provided to the user.

For another aspect of the present invention, information about a billboard advertisement can be imported into the ad retrieval system. In one exemplary embodiment, the information can include the location of the billboard, the product or service that is being offered in the billboard advertisement, a script of the words in the billboard advertisement, and contact information for the seller associated with the billboard advertisement. The billboard advertisement can be displayed at a location where it can be viewed by the consuming public. The billboard advertisement can include a reference that indicates information about the billboard advertisement is available at the ad retrieval system. A user can access the ad retrieval system via telephone and request information about an advertisement. An interactive voice response system at the ad retrieval system can provide a first set of voice prompts that request information about the billboard advertisements from the user. Based on the responses received from the user, a set of search parameters can be generated and a search of the ad database can be conducted. Based on information retrieved from the search of the ad database, a telephone connection can be created between the user and a seller associated with the advertisement that the user was seeking information about.

For another aspect of the present invention the ad retrieval system can receive a telephonic request for information about a product associated with an advertisement from a user. A set of voice prompts in the ad retrieval system can request information about the advertisement and add responses to the voice prompts to a set of search parameters. The search parameters can be utilized to search an ad database to locate the advertisement sought by the user. A determination can be made as to whether any of the advertisements in the ad database match the search parameters. Advertisements that match the search parameters can be played for the user. The ad retrieval system can also connect the user, via telephone, to the seller associated with the advertisement retrieved from the search of the ad database.

### BRIEF DESCRIPTION OF DRAWINGS

For a more complete understanding of the exemplary embodiments of the present invention and the advantages thereof, reference is now made to the following description in conjunction with the accompanying drawings in which:

FIG. 1 is a block diagram illustrating an exemplary system for implementation of various embodiments of the memory portal system;

FIG. 1A is a block diagram illustrating an exemplary advertisement that includes a reference to the memory portal system;

FIG. 2 is a flowchart illustrating the general steps of a process for accessing the memory portal to store and retrieve information about an advertisement in accordance with an exemplary embodiment of the present invention;

FIG. 3 is a flowchart illustrating a process for storing information about an advertisement in the memory portal in accordance with an exemplary embodiment of the present invention;

FIG. 4 is a flowchart illustrating a process for requesting additional information to be stored in the memory portal in accordance with an exemplary embodiment of the present invention;

FIGS. 5 & 5A are flowcharts illustrating a process for determining the advertisement that a customer is searching for in accordance with an exemplary embodiment of the present invention;

FIG. 6 is a flowchart illustrating a process for determining if a party selling a product lists its advertisements on the memory portal system and providing a response to a customer in accordance with an exemplary embodiment of the present invention;

FIG. 6A is a flowchart illustrating an alternative process for determining if a party selling a product lists its advertisements on the memory portal and providing a response to a customer in accordance with an exemplary embodiment of the present invention;

FIG. 7 is a flowchart illustrating a process for determining the ad requested by the customer based on information provided by the customer in accordance with an exemplary embodiment of the present invention;

FIGS. 8 and 8A are flowcharts illustrating a process for determining the billboard advertisement sought by a customer based on information provided by the customer in accordance with an exemplary embodiment of the present invention;

FIG. 9 is a flowchart illustrating a process for providing options to a customer after locating the advertisement being sought by the customer in accordance with an exemplary embodiment of the present invention;

FIG. 10 is a flowchart illustrating a process for a consumer accessing the memory portal system and accessing information stored in the system according to one exemplary embodiment of the present invention;

FIG. 11 is a flowchart illustrating a process for charging an advertiser or member a monetary fee for transferring calls to the advertiser according to one exemplary embodiment of the present invention;

FIG. 12 is a flowchart illustrating a process for accessing one of multiple memory portal databases based on the location of the caller according to one exemplary embodiment of the present invention; and

FIG. 13 is a flowchart illustrating a process for presenting a listing of parties matching at least some of the parameters provided to the memory portal system.

### DETAILED DESCRIPTION OF THE EXEMPLARY EMBODIMENTS

The present invention supports a method and system for alerting customers to the fact that information about an advertisement is available on a memory portal system and providing a memory portal system to retrieve information about advertisements broadcast or displayed to the public. Exemplary embodiments of the invention can be more readily understood by reference to the accompanying figures.

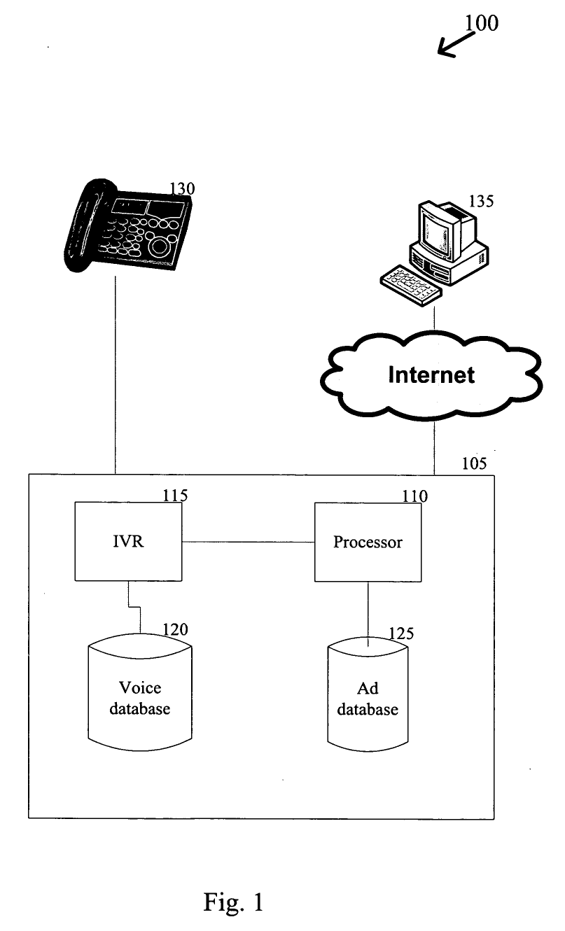

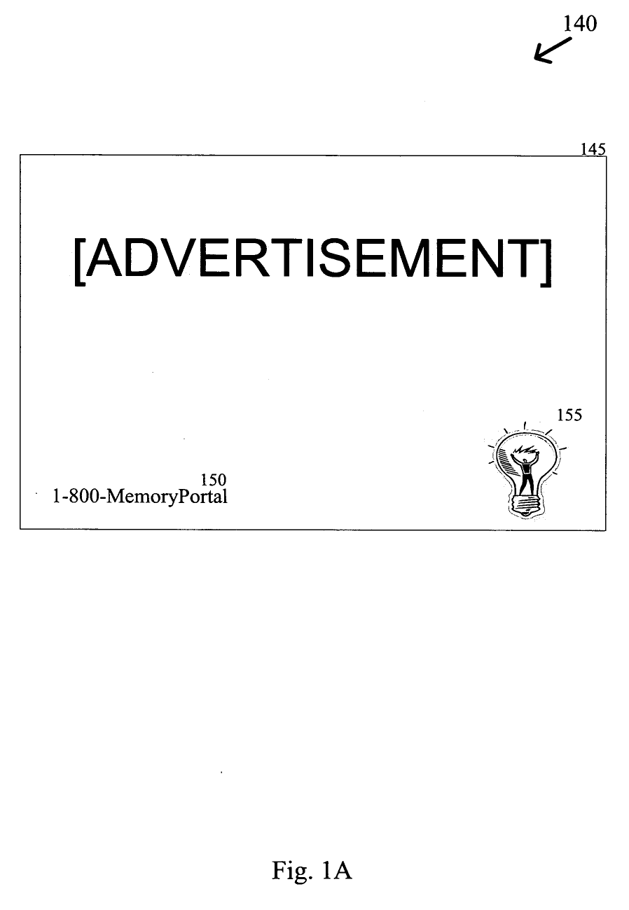

Referring now to the drawings, in which like numerals represent like elements throughout the several figures, aspects of the present invention and an exemplary operating system for the implementation of the present invention will be described. FIG. 1 is a block diagram illustrating a system 100 for providing information to customers about advertisements (“ads”) constructed in accordance with an exemplary embodiment of the present invention. The exemplary ad information system 100 comprises a memory portal 105, a telephone 130, and a personal computer (“PC”) 135. The memory portal 105, can comprise the following functional components: a processor 110, an interactive voice response system (“IVR”) 115, a voice database 120, and an ad database 125.

The processor is communicably attached to the IVR 115, the voice database 120, the ad database 125, the telephone 130, and the PC 135. The processor 110 is capable of retrieving selected speech files from the voice database 120 and sending them to the IVR 115 at the appropriate time for voice message playback. The processor 110 is also capable of receiving voice and audio responses from the telephone 130 and passing that information to the IVR 115 for processing into data, which can be passed back to the processor 110 and stored in the ad database 125. The processor 110 is also capable of storing and retrieving information from the ad database 125 and conducting analysis of the information stored in the ad 125 and voice 120 databases.

The IVR 115 is communicably attached to the processor 110 and the voice database 120. The IVR 115 is capable of receiving voice or data files and converting them into audible speech that can be passed through the processor 110 to the telephone 130. The IVR 115 can provide a customer on the telephone 130 with various voice prompts and accept and process inputs provided by a customer over the telephone 130. Once the IVR 115 has processed the input from the telephone 130, the IVR 115 can pass the processed data to the processor 110 for storage in the ad 125 or voice 120 database. It will be understood by one of ordinary skill in the art that there can be ways to access the memory portal system 105 other than by making a telephone call over a conventional commercial telephone network. For example, a telephone device could be directly wired to the memory portal system 105.

The voice database 120 is communicably connected to the processor 110 and the IVR 115. The voice database 120 generally consists of speech files. Speech files can be of an arbitrary length. A message can be informational, a list of menu options, or a yes/no question. The ad database 125 is communicably attached to the processor 110. The ad database 125 typically includes search parameters and information related to ads. Search parameters can be information provided by a customer over the telephone 130 to the memory portal system 105 about the type of ad they are searching for, including the name of the product, the party who is selling the product, when they heard or saw the ad, where they heard or saw the ad, etc. Information related to the ads can include the name of the product offered in the ad, a description of the ad, where the ad will be broadcast or displayed, when the ad will be broadcast or displayed, keywords in the ad, and a description of the product category for product offered in the ad. The telephone 130 is communicably attached to the processor 110 of the memory portal system 105. The telephone 130 provides a customer access to the memory portal system 105 to find information about an ad that the customer may or may not have previously heard. While a standard telephone 130 is shown, those of ordinary skill in the are will recognize that any telephonic device will satisfy the requirements of this system.

The telephone 130 is communicably connected to the memory portal system 105. Those of ordinary skill in the art will recognize that the telephone should be defined broadly to include, but not be limited to, a telephone, satellite phone, cellular phone, Voice over Internet Protocol (“VOIP”), a PC telephone, or other suitable device. In one exemplary embodiment, the PC telephone can include a computer, cellular telephone, or other phone with an internet connection and a microphone and can allow its user to connect directly to the memory portal system 105 without having to call the memory portal phone number discussed below.

A PC 135 can be communicably connected to the memory portal system 105 either by way of the Internet or hard wired to the memory portal system 105. The PC 135 can include personal data assistants, master/slave systems, mainframe systems, laptops, or other general computing devices well known in the art. The PC 135 can be used by a person to transmit information about ads to the memory portal system 105. This transmitted information can be passed from the PC 135 to the processor 110, which can then store that information in the ad database 125.

FIG. 1A is a block diagram illustrating an exemplary method 140 for providing an advertisement with a reference that alerts a customer that information about the advertisement is available on the memory portal system 105, constructed in accordance with an exemplary embodiment of the present invention. The exemplary method 140 comprises an advertisement 145. The advertisement 145 could represent a billboard ad, an ad displayed over an internet connection, a print media ad, or a still picture of an ad broadcast on a television. The advertisement 145 could include a phone number 150 that is associated with the memory portal system 105. In one exemplary embodiment, a single phone number 150 would be used to contact the memory portal system 105. In this exemplary embodiment, all advertisements 145 that included the phone number 150 in their advertisement 145 would have the same phone number 150 even if the ads are from different sellers. The phone number 150 could be the actual number to call or a fictional one, such as 1-800-MEMORYPORTAL, in which a portion of the term would be used in locating the actual phone number. In one exemplary embodiment, the phone number for the memory portal system is 1-800-989-2411. In an alternative embodiment, the advertisement 145 could include a mark, symbol, or emblem 155 that could be placed on all advertisements 145 that have information accessible in the memory portal system 105. The mark, symbol, or emblem 155 would alert those viewing the advertisement 145 that information about the advertisement 145 is available on the memory portal system 105. Those viewing the advertisement 145 would also associate the mark, symbol, or emblem 155 with the telephone number to contact the memorial portal system 105. Those of ordinary skill in the art will recognize that other methods could be used to represent to a customer that information is available on the memory portal system 105. For example, a sound or series of sounds could be broadcast along with an ad on radio or television, whereby the sounds would signal to the customer that information about the ad is available on the memory portal 105.

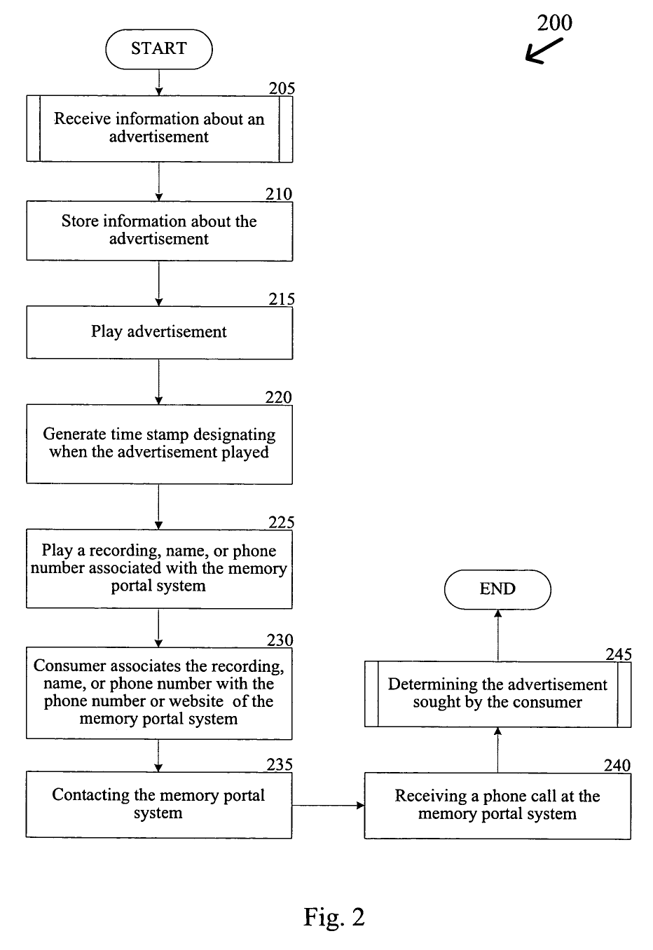

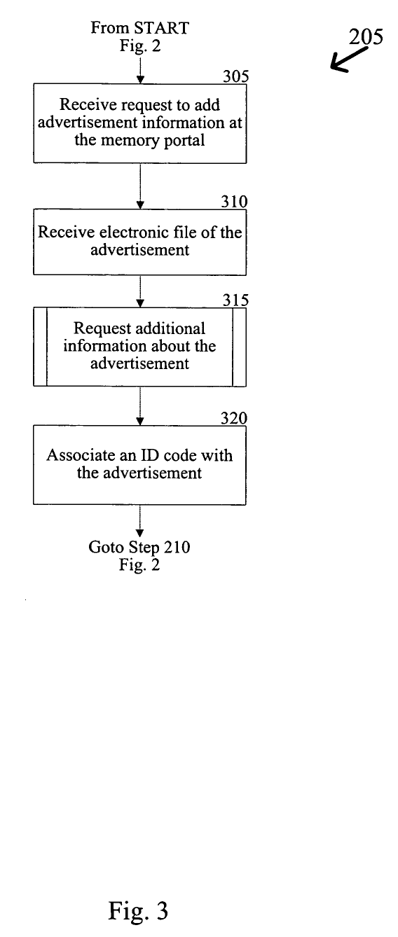

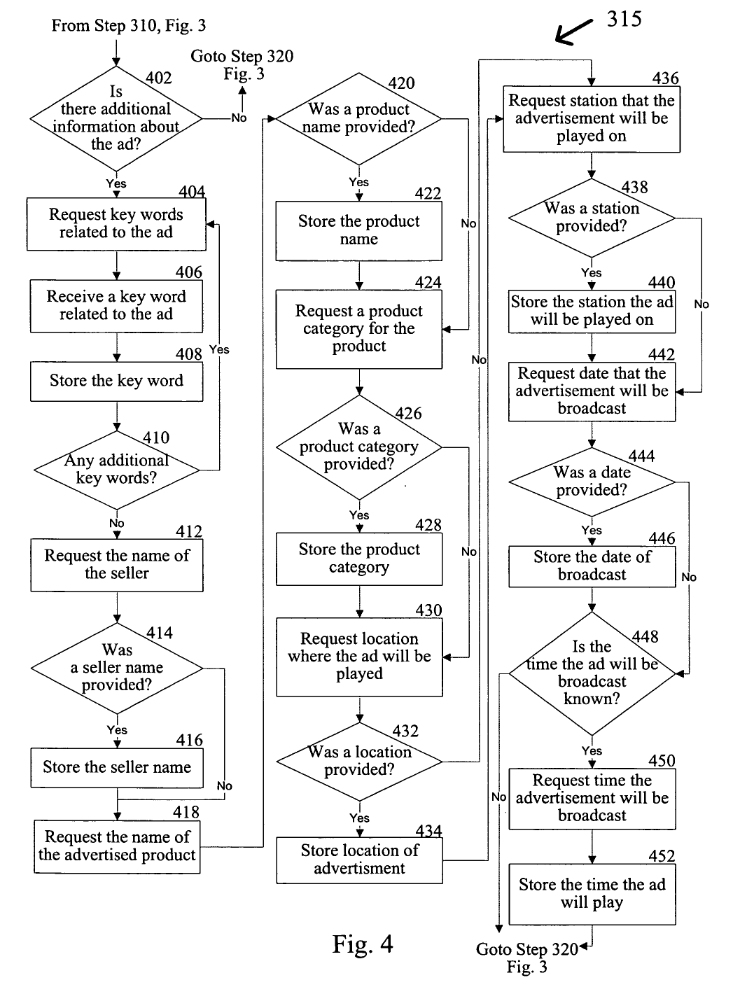

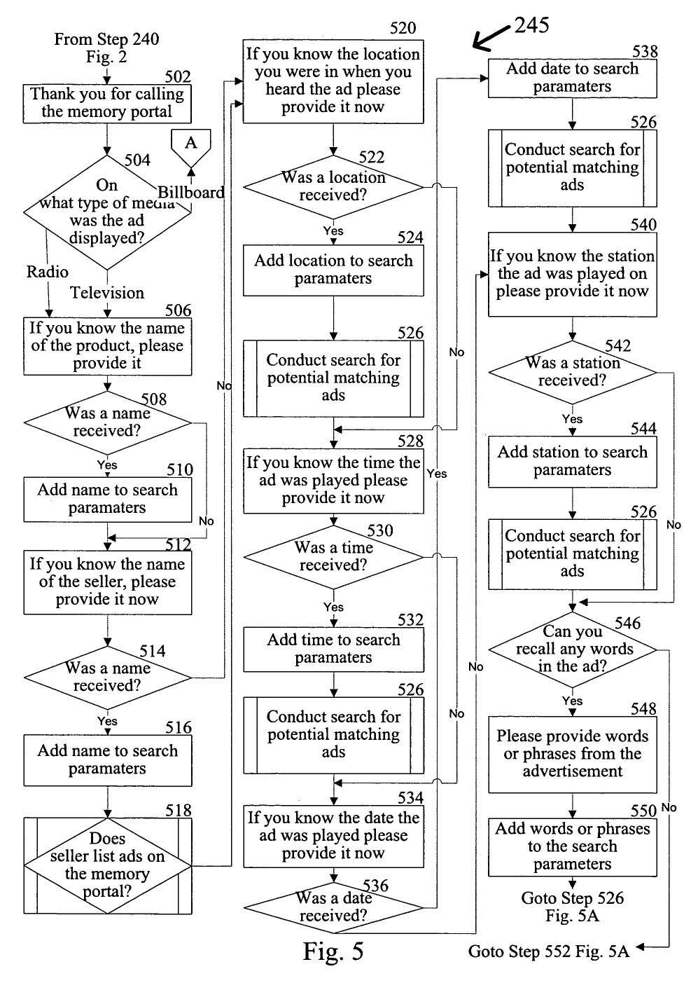

FIGS. 2-13 are logical flowchart diagrams illustrating the exemplary methods for obtaining information about ads from the memory portal system 105. FIG. 2 is a logical flowchart diagram presented to illustrate the general steps of an exemplary process 200 for accessing the memory portal 105 to store and retrieve information about an advertisement 145, within the operating environment of the exemplary ad information system 100 of FIG. 1.

Now referring to FIGS. 1 and 2, the exemplary method 200 begins at the START step and proceeds to step 205, where the memory portal system 105 receives information about an ad. The information is typically received from a PC 135 at the processor 110. The information is typically stored in the ad database 125. In one exemplary embodiment, information about the ad can include the product being offered in the ad, the name of the seller, the product category of the product being offered, keywords in the ad, when and where the ad will be played, the media that the ad will be played on, and a copy or reproduction of the advertisement. The copy of the advertisement could be in the form of a .WAV file or other sound file format, a recording, a digital picture of the advertisement, or other known methods of copying and recording audio, video, and photographic images. In step 210, the information received regarding the ad is stored in the memory portal 105. In one exemplary embodiment, the information is stored in the ad database 125.

The ad is broadcast, played, or made available for viewing in step 215. The ad could be broadcast over radio, television, or print media. The ad could also be displayed on a billboard or in an ad transmitted over the Internet. In step 220, a time stamp can be generated at the time the ad was played. The time stamp would typically be made by the party who is broadcasting the ad. A time stamp would generally be used if information regarding when the ad was to be broadcast or displayed was not known at the time the information about the ad was stored in the ad database 125. The time stamp information can then be transmitted to the memory portal 105 by way of telephone 130 or PC 135. In one exemplary embodiment the time stamp is transmitted to the memory portal 105 along with an ad identification (“ID”) code. The ad identification code can be generated by the processor 110 at the time the initial information for the ad is stored in the ad database 125.

A tag, recording, name, symbol, or phone number associated with the memory portal 105 is broadcast, played, or made available for viewing in step 225. The ad will typically include information that will alert a customer viewing or hearing the ad to the fact that information about the ad can be found on the memory portal 105. In one exemplary embodiment, all billboard ads that have information included in the memory portal 105 could include the same phone number or a symbol that represents the memory portal 105, as described in FIG. 1A. In another exemplary embodiment, a radio ad that has information included in the memory portal 105 could include a sound or series of sounds that conveys to the consumer that information about the ad can be found in the memory portal 105. In another exemplary embodiment, all radio ads having information included in the memory portal 105 could include the broadcast of the same phone number. This single phone number could then be used by a customer to access the memory portal 105 and search for information about any advertisement played on any medium. In another exemplary embodiment both visual and/or audio representations as discussed above could be used in a television or Internet ad to alert a person that information about the ad can be found at the memory portal 105. In one exemplary embodiment, the phone number for the memory portal system is 1-800-989-2411.

In step 230, the customer associates the tag, recording, name, symbol, keywords, or phone number with the phone number or website for the memory portal system 105. In step 235, the customer contacts the memory portal system 105. The customer typically contacts the memory portal system 105 through the use of a single telephone number at a telephone 130. In another exemplary embodiment, the memory portal system 105 can be contacted over the Internet through the use of a single website for all ads. The memory portal system 105 receives the phone call or internet connection in step 240. In one exemplary embodiment, the phone call is routed from the telephone 130 to the processor 110 in the memory portal system 105. In step 245, the memory portal system 105 determines the ad being sought by the consumer. The process then continues to the END step.

FIG. 3 is a logical flowchart diagram presented to illustrate the steps of an exemplary process 205 for storing information about an ad in the memory portal 105, within the operating environment of the exemplary ad information system 100 of FIG. 1. Referencing FIGS. 1, 2, and 3, the exemplary method 205 begins at the START step of FIG. 2 and continues to step 305, where a request is received to add information about an ad to the memory portal 105. The request is generally sent from a PC 135 to the processor 110. The request can be made by the seller of the product being advertised, the advertising agency handling the distribution of the ad, or the station, network, publishing group, or internet site handling the broadcast of the ad. In step 310, the ad is transmitted to the processor 110. The ad can be transmitted to the processor 110 as one or more files, including .WAV files, .MPEG files, .WMA files, QuickTime files, or other sound file formats. Additionally, an audio copy of the ad can be directly recorded by the memory portal system 105 via the telephone 130.

In step 315 the processor 110 transmits a request to the PC 135 or telephone 130 for additional information about the ad. The additional information can be transmitted to the memory portal system 105 in the form of database files, or the memory portal system 105 can seek the additional information via the PC 135 in a request/response format. The database files can include information about the ad, including the product being offered in the ad, the name of the seller, the product category of the product being offered, keywords, when and where the ad will be played or displayed, the media that the ad will be played or displayed on, and a description of the ad and its background (typically used for billboard ads). Keywords can include some or all of the words in the advertisement. Keywords also can be words provided by the advertiser or the memory portal that are associated with the advertiser. For example, the key words for a restaurant can include the items on the restaurant's menu, or typical items found at that type of restaurant (i.e., calamari for an Italian restaurant). In one exemplary embodiment, the keywords include a combination of the words in the advertisement and the words provided by the advertiser or the memory portal. In another exemplary embodiment, keywords do not include the name of the business or the address of the business. An ad ID code is associated with an ad in step 320. In addition, the IVR 115 can receive the advertisement and generate a transcription of the advertisement and add the words in the transcription to the list of keywords for the advertisement or the business in the ad database 125. The ad ID code is typically generated by the processor 110. The ad ID code is transmitted to the party sending the information via the phone 130 or the PC 135. The ad ID code is also stored in the ad database 125 with the ad and the information about the ad. The process continues to step 210 of FIG. 2.

FIG. 4 is a logical flowchart diagram presented to illustrate the steps of an exemplary process 315 for requesting and receiving additional information about an ad to be stored in the memory portal system 105, within the operating environment of the exemplary ad information system 100 of FIG. 1. Referencing FIGS. 1, 3, and 4, the exemplary method 315 begins at step 310 of FIG. 3 and continues to step 402, where an inquiry is conducted to determine if there is additional information about the ad. The determination can be made by sending a request from the processor 110 to the PC 135 asking for addition information. If there is additional information, the “Yes” branch is followed to step 404 where keywords related to the ad are requested by the processor 110 of the memory portal system 105. Otherwise, the “No” branch is followed to step 320 of FIG. 3. The request is typically sent to the PC 135. Keywords can include words people generally associate with the ad, the words in the ad, words that describe the benefits of the brand or product, or words that describe the picture or action taking place in the ad. In step 406, a keyword related to the ad is received by the processor. In one exemplary embodiment, keywords do not include the name of the business or the address of the business associated with the advertisement. The processor 110 can then store the keyword in the ad database 125 in step 408.

An inquiry is conducted in step 410 to determine if there are additional keywords related to the ad. If so, the “Yes” branch returns to step 404 to request another keyword for the ad at the PC 135. In one exemplary embodiment, the request for keywords can request and receive multiple keywords at one time and not just one keyword at a time. If there are no additional keywords that are to be input into the memory portal 105, the “No” branch is followed to step 412 where a request for the name of the seller is sent from the processor 110 to the PC 135. In step 414, an inquiry is conducted to determine if the name of the seller of the product in the ad was provided. If the seller's name was provided, the “Yes” branch is followed to step 416 where the seller's name is passed from the processor 110 to the ad database 125 where it is stored. If the seller's name was not provided, the “No” branch is followed to step 418. Information is typically considered not provided when the PC 135 sends the processor's request back to the processor 110 without any information.

The name of the product being promoted in the ad is requested in step 418. In step 420, an inquiry is conducted to determine if the name of the product was received by the processor 110 from the PC 135. If so, the “Yes” branch is followed to step 422 where the processor 110 stores the name of the product in the ad database 125. Otherwise, the “No” branch is followed to step 424. In step 424, the processor 110 requests the product category for the product from the PC 135. For example, an ad can be promoting the newest car being offered by a well known car manufacturer. The name of the car manufacturer or the name of the dealership would typically be the seller, the make or model of the car would typically be the product being offered, and “car” would be the product category of the product being offered. In step 426, an inquiry is conducted to determine if a product category was provided by the PC 135 to the processor 110. If so, the “Yes” branch is followed to step 428 where the processor 110 stores the product category in the ad database 125. If a product category was not provided, the “No” branch is followed to step 430.

In step 430, a request is made by the processor 110 to the PC 135 for the location where the ad will be played or displayed. The location can include the state or city in which the ad is played, a portion of a city, a precise address, the call letters of the television or radio station, the format for the radio station on which the ad was heard (i.e., sports, jazz, rock, talk, etc.), the format for the television station on which the ad was heard (i.e., network, cable, sports, historical, learning, music, etc.), the time of day or day part (i.e., morning, lunch, noon, evening, time segments such as 11-1 or 4-7, etc.), or proximity to major roads for billboards. In step 432, an inquiry is conducted to determine if a location was provided by the PC 135 to the processor 110. If so, the “Yes” branch is followed to step 434 where the processor 110 stores the location in the ad database 125. Otherwise, the “No” branch is followed to step 436, where the processor 110 sends a request to the PC 135 for the station that the ad will be played on. The station can include the radio or television station, the Internet site that the ad was displayed on, or the name of the print media that the ad was displayed in, such as the magazine or newspaper name. The station can also be represented by its call letters, its frequency or amplitude or its channel number.

In step 438, an inquiry is conducted to determine if a station was provided by the PC 135 to the processor 110. If so, the “Yes” branch is followed to step 440, where the processor 110 stores the station name in the ad database 125. If a station name is not provided, the “No” branch is followed to step 442. The processor sends a request to the PC 135 for the date that the ad will be played or displayed in step 442. In step 444, an inquiry is conducted to determine if a date was provided by the PC 135 to the processor 110. If a date was provided, the “Yes” branch is followed to step 446 where the date is stored in the ad database 125 by the processor 110. Otherwise the “No” branch is followed to step 448.

In step 448, an inquiry is conducted to determine if the time the ad will be displayed or broadcast is known. Time of broadcast is generally a search parameter for ads broadcast over radio or television. The time provided can be by hour; hour and minute; hour, minute and second; or by day part (i.e., morning, lunch, noon, evening, or time segments such as 11-1 or 4-7, etc.). The party providing the information via the PC 135 may not know the time the ad will be broadcast when they are initially adding the information to the memory portal 105. If the time is not known, the time can be added at a later date using the ad ID code provided in step 320 of FIG. 3. If the time of the broadcast is known, the “Yes” branch is followed to step 450 where the processor 110 requests the time of the broadcast at the PC 135. In step 452, the processor receives the time of the broadcast from the PC 135 and stores it in the ad database 125. The process then continues to step 320 of FIG. 3. Returning to step 448, if the time of the broadcast of the ad is not known, the “No” branch is followed to step 320 of FIG. 3.

Those of ordinary skill in the art will recognize that the same information requested and retrieved in FIG. 4 could be requested from a person on the telephone 130 through the IVR 115. The IVR 115 is capable of retrieving the requests from voice database 120 to the telephone 130. The IVR 115 is also capable of receiving the response from the telephone 130 and converting the audible response into data that can be stored by the processor 110 in the ad database 125.

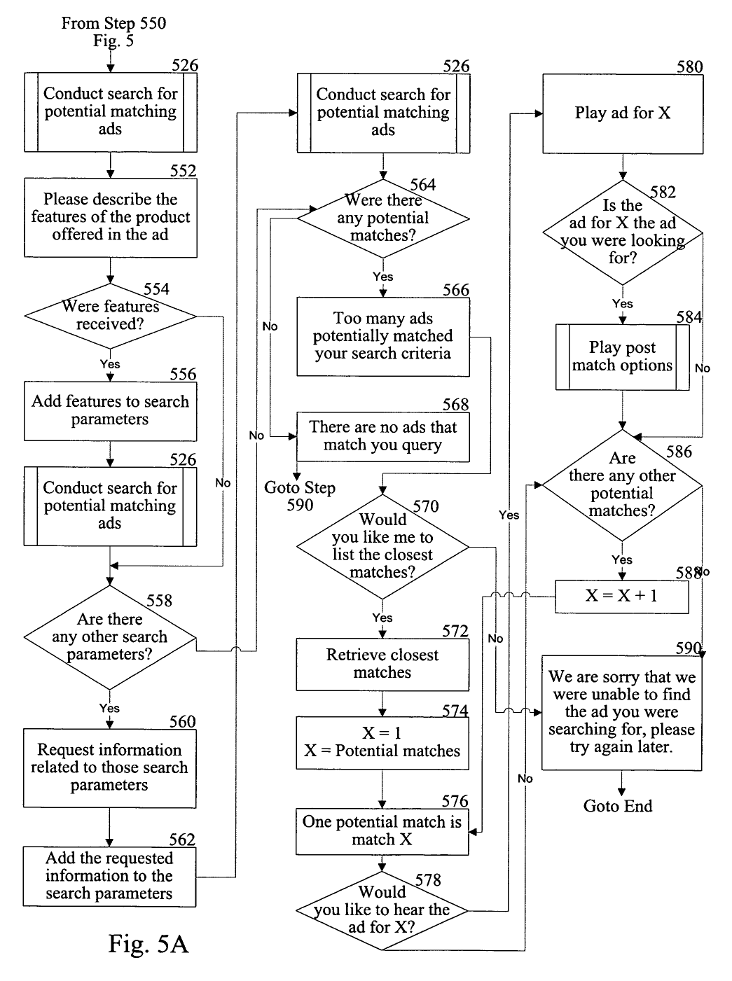

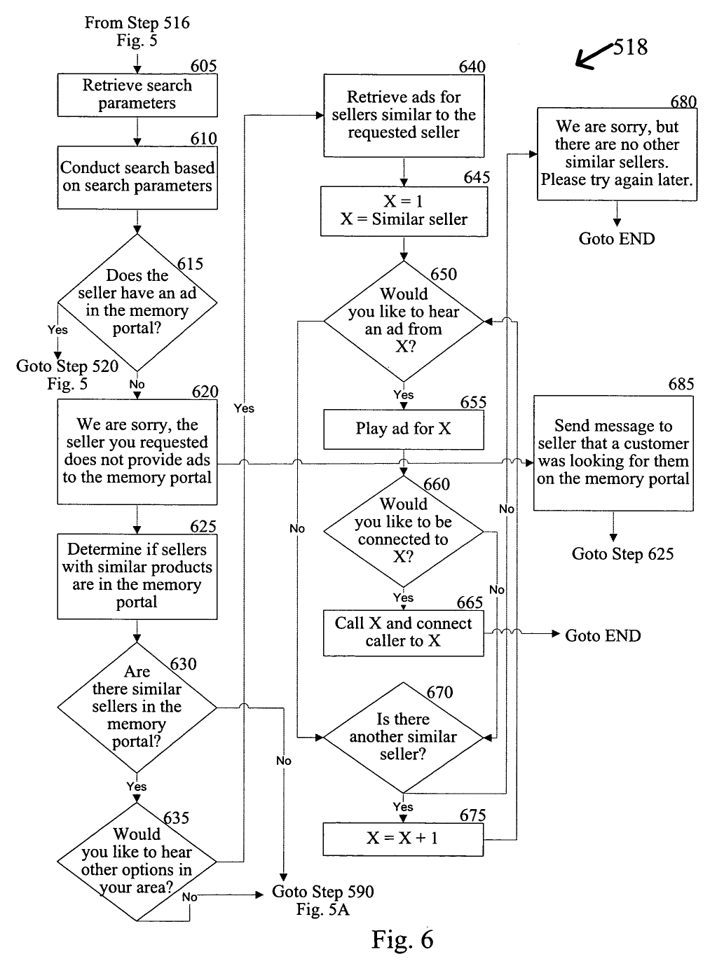

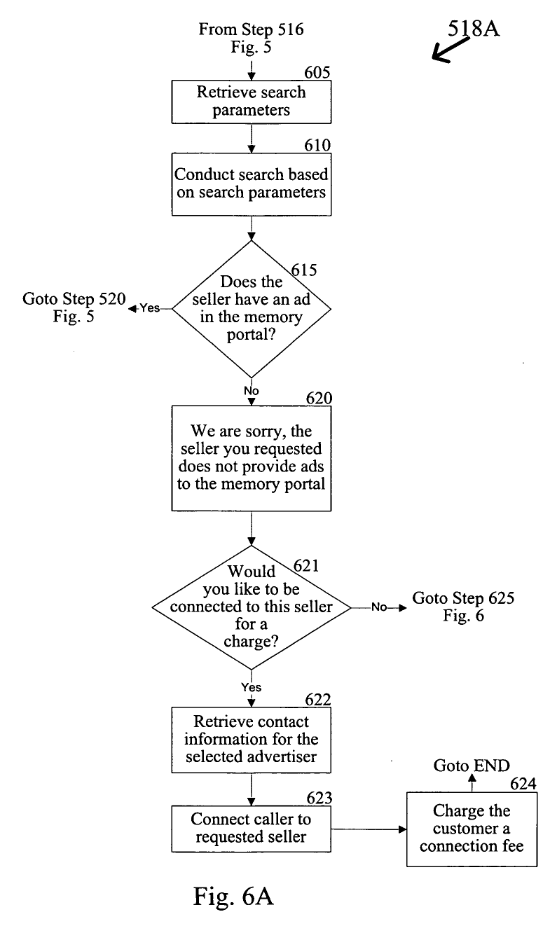

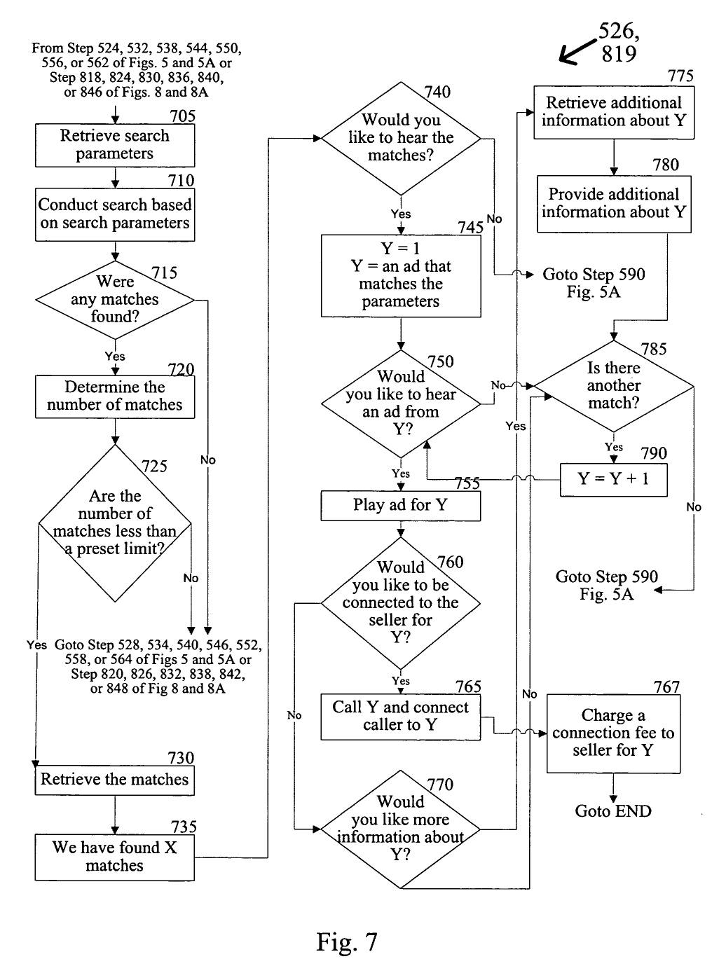

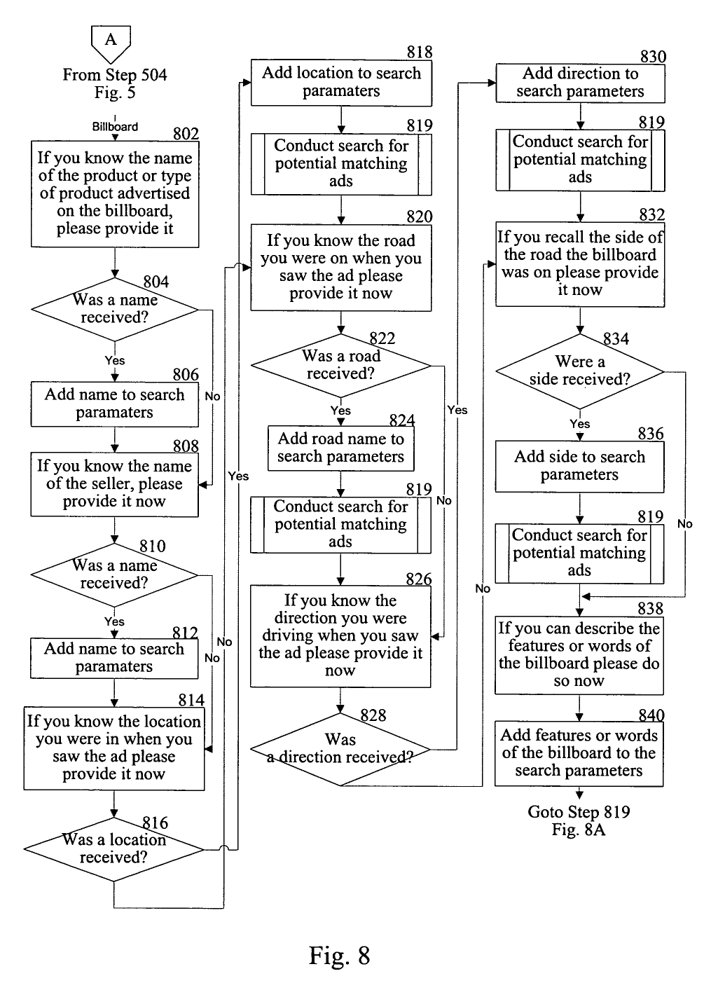

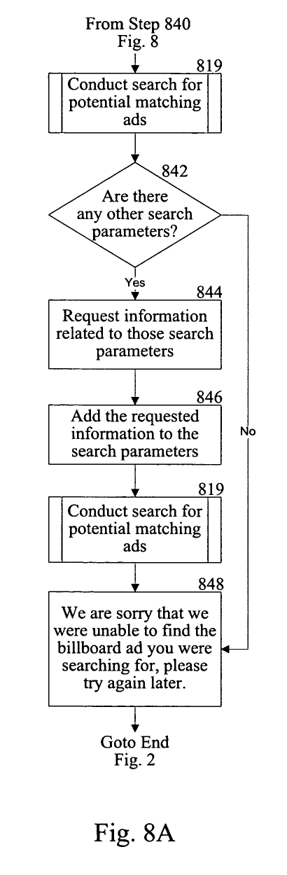

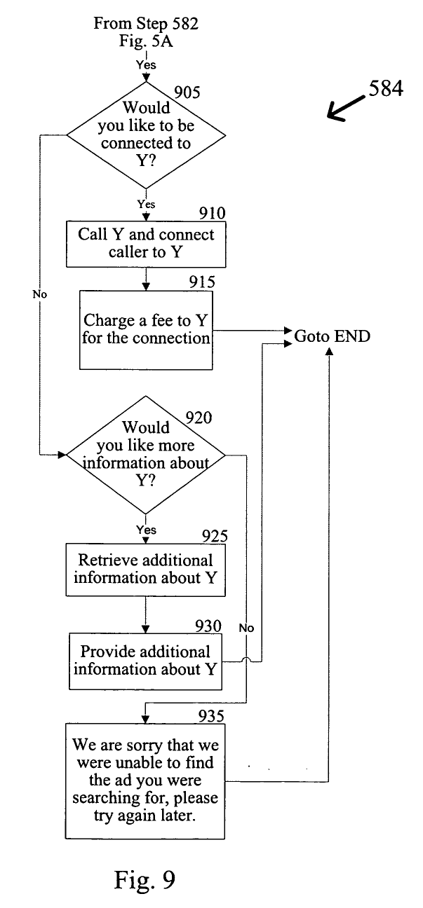

FIGS. 5 and 5A are logical flowchart diagrams presented to illustrate the steps of an exemplary process 245 for determining the advertisement that a customer is searching for, within the operating environment of the exemplary ad information system 100 of FIG. 1. FIGS. 5 and 5A typically reference actions occurring between a customer on a telephone 130 and the IVR 115. The IVR 115 can retrieve requests from the voice database 120 and pass the requests in the form of audible language to the customer on the telephone 130 via the processor 110. The statements made by the IVR 115 in FIGS. 5 and 5A are exemplary and those skilled in the art will recognize that modifications can be made to the statements and requests to convey and receive the same type of information from the customer on the telephone 130. For ease of review, the statements and requests made by the IVR 115 will be placed in quotations.

Referencing FIGS. 1, 2, 5, and 5A, the exemplary method 245 begins at step 240 of FIG. 2 and continues to step 502, where the IVR 115 states “Thank you for calling the memory portal.” In step 504, an inquiry is conducted whereby the IVR 115 asks “On what type of media was the ad displayed?” If the response from the customer on the telephone 130 to the IVR 115 via the processor 110 is that the ad was displayed on a billboard, the “Billboard” branch is followed to FIG. 8. Otherwise the “Radio,” or “Television” branches are followed to step 506. In step 506, the IVR 115 states “If you know the name of the product, please provide it.” In step 508, an inquiry is conducted to determine if a product name was received at the IVR 115 from the customer on the telephone 130. In one exemplary embodiment, the customer could fail to provide the requested information by not responding in a specific period of time. In another exemplary embodiment, the customer could say a word or phrase, such as “I do not know” that could be recognized by the IVR 115 as representing the fact that there is no information for that request. In another exemplary embodiment, the customer could depress one or more keys on the keypad of the telephone 130 that could be recognized by the IVR 115 as representing the fact that there is no information for that request.

If a product name was received, the “Yes” branch is followed to step 510 where the IVR 115 passes the name to the processor 110 for storage in a database. The name, and other search parameters can be stored in the ad database 125, the voice database 120 or some other database that is electronically coupled to the memory portal system 105. For the sake of simplicity, the exemplary embodiment discussed in these figures will describe a system that stores the search parameters in the ad database 125. If a product name is not provided, the “No” branch is followed to step 512 where the IVR 115 states “If you know the name of the seller, please provide it now.” The seller is typically selling the product that is being offered in the ad. The seller could include the manufacturer, a distributor, or a retail store.

In step 514, an inquiry is conducted to determine if the customer provided the name of the seller to the IVR 115. If a name was provided, the “Yes” branch is followed to step 516 where the IVR 115 passes the name to the processor 110 for storage in the ad database 125. The process continues to step 518 where an inquiry is conducted by the processor 110 to determine if the seller lists ads on the memory portal 105. If the seller's name is not provided, the “No” branch is followed to step 520. In step 520, the IVR 115 states “If you know the location you were in when you heard/saw the ad, please provide it now.” In step 522, an inquiry is conducted to determine if a location was received by the IVR 115 from the customer on the telephone 130. The location can include the state, the city, an area of the city, or a specific address where the customer was when they heard or saw the ad.

If a location was received at the IVR 115, the “Yes” branch is followed to step 524 where the IVR 115 passes the location to the processor 110 for storage in the ad database 125. In step 526, a search is conducted to determine if any ads match the search parameters provided by the customer. The search is typically conducted by the processor 110 comparing the parameters provided by the customer to information about the ads in the ad database 125. If a location was not received in step 522, the “No” branch is followed to step 528.

In step 528, the IVR 115 states “If you know the time the ad was played, please provide it now.” In step 530, an inquiry is conducted to determine if a time was received by the IVR 115 from the customer on the telephone 130. The time can include such references as daytime, nighttime, morning, afternoon, evening, or it can be the exact time based on a 12 or 24-hour clock. If a time was received at the IVR 115, the “Yes” branch is followed to step 532 where the IVR 115 passes the time to the processor 110 for storage in the ad database 125. In step 526, a search is conducted to determine if any ads match the search parameters provided by the customer. If a time was not received in step 530, the “No” branch is followed to step 534.

In step 534, the IVR 115 states “If you know the date the ad was played, please provide it now.” In step 536, an inquiry is conducted to determine if a date was received by the IVR 115 from the customer on the telephone 130. The date is typically represented by the month, day, and year, but could also include the day of the week or the season of the year. If a date was received at the IVR 115, the “Yes” branch is followed to step 538 where the IVR 115 passes the date to the processor 110 for storage in the ad database 125. In step 526, a search is conducted to determine if any ads match the search parameters provided by the customer. If a date was not received in step 536, the “No” branch is followed to step 540.

In step 540, the IVR 115 states “If you know the station the ad was played on, please provide it now.” In step 542, an inquiry is conducted to determine if a station was received by the IVR 115 from the customer on the telephone 130. The station can include its call letters, its frequency, amplitude, the station format (i.e., rock, jazz, talk, sports, religious, etc.), or its channel number. If a station was received at the IVR 115, the “Yes” branch is followed to step 544 where the IVR 115 passes the station to the processor 110 for storage in the ad database 125. In step 526, a search is conducted to determine if any ads match the search parameters provided by the customer. If a station was not received in step 542, the “No” branch is followed to step 546.

In step 546, an inquiry is conduct by the IVR 115 which asks “Can you recall any words in the ad?” If the customer on the telephone 130 can recall words in the ad, the “Yes” branch is followed to step 548. Otherwise the “No” branch is followed to step 552 of FIG. 5A. The customer can respond by either pushing a key on the keypad of the telephone 130 or answering in the affirmative, which can be processed by the IVR 115. In step 548, the IVR 115 states “Please provide words or phrases from the ad.” Words or phrases provided by the customer on the telephone 130 to the IVR 115 are passed to the processor 110 and stored with the other search parameters in the ad database 125. The process continues in step 526 of FIG. 5A, where a search is conducted to determine if any ads match the search parameters provided by the customer.

In step 552, the IVR 115 states “Please describe the features of the product offered in the ad.” In step 554, an inquiry is conducted to determine if any features were received by the IVR 115 from the customer on the telephone 130. If features were received at the IVR 115, the “Yes” branch is followed to step 556 where the IVR 115 passes the features to the processor 110 for storage in the ad database 125. In step 526, a search is conducted to determine if any ads match the search parameters provided by the customer. If features were not received in step 554, the “No” branch is followed to step 558. Those of ordinary skill in the art will recognize that the features of the product or words in the ad can be passed to the IVR 115 one at a time, with the IVR 115 making a request for each additional feature or word, or in bulk, with the IVR 115 capable of separating and storing each feature or word with the other search parameters in the ad database 125.

In step 558, an inquiry is conducted to determine if the memory portal 105 contains other search parameters to request about the ad through the IVR 115. If there are no other search parameters, the “No” branch is followed to step 564. Otherwise, the “Yes” branch is followed to step 560, where the IVR 115 sends a request to the telephone 130 for responses related to those additional search parameters. In step 562, the response by the customer on the telephone 130 to the request for additional search parameters is passed from the IVR 115 to the processor 110 for storage in the ad database 125 with the other search parameters. In step 526, a search is conducted to determine if any ads match the search parameters provided by the customer.

In step 564, an inquiry is conducted to determine if the search parameters provided by the customer matched any ad in the ad database 125. If not, the “No” branch is followed to step 568, where the IVR 115 states “There are no ads that match your query. The process then continues to step 590. If the search parameters did match some ads in the ad database 125, the “Yes” branch is followed to step 566 where the IVR 115 states “Too many ads potentially matched your search criteria.” The process continues to step 570, where the IVR 115 inquires “Would you like me to list the closest matches?” In one exemplary embodiment, the closest matches could include those ads that matched the greatest number of search parameters. In another exemplary embodiment, certain search parameters could be given greater weight than others in determining potential matches. For example, product categories, seller, and location (for example the city were the ad took place) could potentially provide more relevant matches for what the customer is searching for than the date or time the ad was played.

If the customer responds that they do not want to hear the closest matches, the “No” branch is followed to step 590. Otherwise, the “Yes” branch is followed to step 572 where the processor 110 retrieves the closest matches from the ad database 125 by comparing the search parameters provided by the customer to the ad information. In step 574, a counter variable X is set equal to one. The counter variable X represents potential matches to the customer's search parameters. In one exemplary embodiment, when providing information about X, the IVR 115 will generally provide the name of the seller and the product. In step 576, the IVR 115 states “One potential match is X.” In step 578, the IVR 115 inquires “Would you like to hear the ad for X?” If the customer's response to the IVR 115 is that they would not like to hear an ad for X, then the “No” branch is followed to step 586. If the customer would like to hear an ad for X, the “Yes” branch is followed to step 580 where the ad for X is retrieved from the ad database 125 by the processor 115 and played. The playing of the ad can include a .WAV file or other similar audio clip of the ad. The playing of the ad also can include a reading of the words included in the ad by passing the words from the processor 110 to the IVR 115. The playing of the ad could also include transmitting a file to the telephone 130 that provides video or video and sound replication of the ad on the telephone 130.

In step 582, the IVR 115 inquires “Is the ad for X the ad you were searching for?” If the customer responds that the ad for X is the correct ad, the “Yes” branch is followed to step 584 where post match options are provided to the customer by the IVR 115 via the processor 110. Otherwise, the “No” branch is followed to step 586. In step 586, an inquiry is conducted to determine if there are any other potential matches that were retrieved by the processor 110 from the ad database 125. If additional potential matches do exist, the “Yes” branch is followed to step 588 where the counter variable X is incremented by one. The process then returns to step 576 for the retrieval of the next potential match. If no additional potential matches exist, the “No” branch is followed to step 590 where the IVR 115 states “We are sorry that we were unable to find the ad you were searching for. Please try again later.” The process then continues to the END step.

FIG. 6 is a logical flowchart diagram presented to illustrate the steps of an exemplary process 518 for determining if a party selling a product lists its ads on the memory portal 105 and providing a response to a customer, within the operating environment of the exemplary ad information system 100 of FIG. 1. Referencing FIGS. 1, 5, 5A, and 6, the exemplary method 518 begins at step 516 of FIG. 5 and continues to step 605, where the processor 110 retrieves the search parameters provided by the customer from the ad database 125. In step 610, the processor 110 conducts a search of the ad information in the ad database 125 based on the search parameters. In one exemplary embodiment, the search parameters would include the name of the seller.

In step 615, an inquiry is conducted to determine if the seller lists any ads in the memory portal 105. If the seller does list ads in the memory portal 105, the “Yes” branch is followed to step 520 of FIG. 5. Otherwise, the “No” branch is followed to step 620, where the IVR 115 states “We are sorry, the seller you requested does not provide ads to the memory portal.” In one exemplary embodiment, after the processor 110 determines that the requested seller is not in the ad database 125, the processor 110 could generate a message to the requested seller that a customer was searching for information about them in the memory portal 105, as shown in step 685. The message could be sent to the requested seller electronically, such as via phone or electronic mail, or could be sent via conventional mail. In step 625, the processor 110 conducts a search of the ad database 125 to determine if sellers of products similar to the product being sought by the customer are listed in the memory portal 105. For example, if a customer was searching for a particular steak restaurant in Atlanta, Ga., but that restaurant did not list its ads on the memory portal 105, the processor could search for other steak restaurants in the Atlanta, Ga. area.

In step 630, an inquiry is conducted to determine if ads for similar sellers are listed in the ad database 125 of the memory portal 105. If not, the “No” branch is followed to step 590 of FIG. 5A. If ads for similar sellers are listed, the “Yes” branch is followed to step 635. In step 635, the IVR 115 inquires of the customer “Would you like to hear other options in you area?” If the customer responds in the negative, the “No” branch is followed to step 590 of FIG. 5A. Otherwise, the “Yes” branch is followed to step 640, where the processor 110 retrieves ads from the ad database 125 for sellers and products similar to those requested by the customer. In step 645, counter variable X is set equal to one. Counter variable X represents matches for ads of similar sellers and products.

In step 650, the IVR 115 inquires “Would you like to hear an ad from X?” If the customer does not want to hear an ad from X, the “No” branch is followed to step 670. If they would like to hear the ad, the “Yes” branch is followed to step 655, where the processor 110 retrieves and plays the ad for X. As stated earlier, the playing of the ad can include a .WAV file or other similar audio clip of the ad. The playing of the ad also can include a reading of the words included in the ad by passing the words from the processor 110 to the IVR 115. The playing of the ad could also include transmitting a file to the telephone 130 that provides video or video and sound replication of the ad on the telephone 130.

In step 660, the IVR 115 inquires “Would you like to be connected to X?” If so, the “Yes” branch is followed to step 665 where the processor 110 retrieves the contact information for X from the ad database 125, places a call to X, and connects the customer to X. In one exemplary embodiment, the memory portal 105 could charge X a monetary fee for connecting a customer to them. In another exemplary embodiment, the memory portal 105 could charge the customer a monetary fee for providing the connection service. The process then continues to the END step.

If the customer does not want to be connected to X, the “No” branch is followed to step 670, where the processor 110 determines if there is another similar seller. If so, the “Yes” branch is followed to step 675, where the counter variable X is incremented by one. The process then returns to step 650. If there are no additional similar sellers, the “No” branch is followed to step 680, where the IVR 115 states to the customer via the telephone 130 “We are sorry, but there are no other similar sellers. Please try again later.” The process then continues to the END step.

FIG. 6A is a logical flowchart diagram presented to illustrate the steps of an alternate exemplary process 518A for determining if a party selling a product lists its ads on the memory portal 105 and providing a response to a customer, within the operating environment of the exemplary ad information system 100 of FIG. 1. Referencing FIGS. 1, 5, 5A, 6, and 6A, the exemplary method 518A begins at step 516 of FIG. 5 and continues to step 605, where the processor 110 retrieves the search parameters provided by the customer from the ad database 125. In step 610, the processor 110 conducts a search of the ad information in the ad database 125 based on the search parameters. In step 615, an inquiry is conducted to determine if the seller lists any ads in the memory portal 105. If the seller does list ads in the memory portal 105, the process continues to step 520 of FIG. 5. Otherwise, the “No” branch is followed to step 620, where the IVR 115 states “We are sorry, the seller you requested does not provide ads to the memory portal.”

In step 621, the IVR 115 inquires “Would you like to be connected to this seller for a charge?” If the customer responds in the negative, the “No” branch is followed to step 625 of FIG. 6. Otherwise the “Yes” branch is followed to step 622, where the processor 110 retrieves the contact information for the selected seller. In one exemplary embodiment the processor 110 is capable of accessing the Internet to retrieve information related to contact information for potential sellers. In another exemplary embodiment, contact information, such as electronic telephone directories, can be stored in the ad database 125, the voice database 120, or some other database accessible to the processor 110 and the memory portal 105. In step 623, the processor 110 contacts the requested seller (typically via telephone) and connects the customer to the requested seller. The memory portal 105 charges a connection fee to the customer in step 624. In one exemplary embodiment, the fee will be charged to the telephone 130 used by the customer to request the information. In some instances it would not be practical to charge the fee to the telephone 130, such as when a pay telephone is used. In those instances the customer could pay for the call with a credit card, debit card, or other payment instrument. The process then continues to the END step.

FIG. 7 is a logical flowchart diagram presented to illustrate the steps of an exemplary process 526 for determining the ad requested by the customer based on search parameters provided by the customer, within the operating environment of the exemplary ad information system 100 of FIG. 1. Referencing FIGS. 1, 5, 5A, and 7, the exemplary method 526 begins at step 705, where the processor 110 retrieves the search parameters provided by the customer from the ad database 125. The processor conducts a search of the ads in the ad database 125 based on the search parameters in step 710.

In step 715, an inquiry is conducted to determine if any ads matched the search parameters. An ad could match the search parameters if it matches all or some of the search parameters depending on the sensitivity of the search. If no ads in the ad database 125 matched the search parameters, the “No” branch is followed to the step following step 526 in FIGS. 5, 5A, 8, and 8A. The steps following step 526 are as follows: steps 528, 534, 540, and 546 of FIG. 5; steps 552, 558, and 564 of FIG. 5A; steps 820, 826, 832, and 838 of FIG. 8; and steps 842 and 848 of FIG. 8A. The search conducted in step 526 can be conducted after each new search parameter is received from a customer, intermittently as search parameters are received from a customer, after all the search parameters are received from a customer, or can only begin after a certain number of search parameters are received from a customer. If ads matching the search parameters were found in the ad database 125, the “Yes” branch is followed to step 720.

The processor 110 determines the number of matches in step 720. In step 725, an inquiry is conducted to determine if the number of matches is less than a preset limit. A preset limit will typically be introduced to restrict the system from providing a customer with so many matches that they would not want to wade through all of the matches to find the ad they are actually searching for. In one exemplary embodiment, the preset limit is six, so that the memory portal 105 will only provide the matches to the customer via the telephone 130 if there are five or fewer matches. If the number of matches is not less than the preset limit, the “No” branch is followed to the step following step 526 in FIGS. 5, 5A, 8, and 8A. Otherwise, the “Yes” branch is followed to step 730, where the processor 110 retrieves the matching ads from the ad database 125.

In step 735, the IVR 115 states to the customer “We have found X matches,” with X representing the number of ads that matched the search parameters. In step 740, the IVR 115 inquires “Would you like to hear the matches?” If the customer does not want to hear the matches, the “No” branch is followed to step 590 of FIG. 5A or step 848 of FIG. 8A. If the customer signals that they would like to hear the matches, the “Yes” branch is followed to step 745 where counter variable Y is set equal to one. Counter variable Y represents an ad that matches the search parameters provided by the customer. In step 750, the IVR 115 inquires of the customer “Would you like to hear an ad for Y?” If the customer does not want to hear an ad for Y, the “No” branch is followed to step 785. Otherwise the “Yes” branch is followed to step 755 where the processor 110 plays the ad for Y to the customer via the telephone 130.

In step 760, the IVR 115 asks “Would you like to be connected to the seller for Y” If so, the “Yes” branch is followed to step 765, where the processor 110 retrieves the contact information for Y ad and connects the customer to the seller of the product offered in the Y ad. In step 767, the memory portal 105 charges a connection fee to the seller for the product offered in the Y ad. Returning to step 760, if the customer does not want to be connected, the “No” branch is followed to step 770. In step 770, the IVR 115 inquires “Would you like more information about Y?” If the customer signals that they do not want additional information, the “No” branch is followed to step 785. Otherwise, the “Yes” branch is followed to step 775, where additional information about Y can be retrieved by the processor 110. For example, additional information for a restaurant can include the hours of operation, items on the menu, and directions to the restaurant's location. The additional information can be stored in the ad database 125, the voice database 120, or any other database communicably connected to the memory portal 105, whether internal or external.

The processor 110 provides the additional information about Y to the customer via the telephone 130 in step 780. The information could be in the form of a .WAV or other audio file, video or text imaging files, or could be transmitted to the customer using the IVR 115. In step 785, an inquiry is conducted to determine if there is another ad that matches the search parameters. If so, the “Yes” branch is followed to step 790, where the counter variable Y is incremented by one. The process then returns to step 750. If there are no additional matches, the “No” branch is followed to step 590 of FIG. 5A or step 848 of FIG. 8A.

FIGS. 8 and 8A are logical flowchart diagrams presented to illustrate the steps of an exemplary process for determining the billboard advertisement sought by a customer based on search parameters provided by the customer, within the operating environment of the exemplary ad information system 100 of FIG. 1. Referencing FIGS. 1, 5, 8, and 8A, the exemplary method begins at step 504 of FIG. 5 and continues to step 802, where the IVR 115 states “If you know the name of the product or type of product advertised on the billboard, please provide it now.” In step 804, an inquiry is conducted to determine if a name was received by the IVR 115 from the customer on the telephone 130. If a name was received at the IVR 115, the “Yes” branch is followed to step 806 where the IVR 115 passes the name or product type to the processor 110 for storage in the ad database 125. If a name was not received in step 804, the “No” branch is followed to step 808.

In step 808, the IVR 115 states “If you know the name of the seller for the product offered in the ad, please provide it now.” In step 810, an inquiry is conducted to determine if a seller's name was received by the IVR 115 from the customer. If a name was received at the IVR 115, the “Yes” branch is followed to step 812 where the IVR 115 passes the name to the processor 110 for storage in the ad database 125. If a name was not received in step 810, the “No” branch is followed to step 814. While not shown in this exemplary embodiment, those of skill in the art will recognize that the processes described in FIGS. 6 and 6A could be added to the exemplary process in FIGS. 8 and 8A so as to determine if the seller provides ads to the memory portal 105 and to provide the customer with additional options based on that determination.

In step 814, the IVR 115 states “If you know the location you were in when you saw the ad, please provide it now.” In step 816, an inquiry is conducted to determine if a location was received by the IVR 115 from the customer. The location can include the city, a part of a city, a road, or landmark. If a location was received at the IVR 115, the “Yes” branch is followed to step 818 where the IVR 115 passes the location to the processor 110 for storage in the ad database 125. In step 819, a search is conducted to determine if any billboard ads match the search parameters provided by the customer. If a location was not received in step 816, the “No” branch is followed to step 820. Those of ordinary skill in the art will recognize that the search step of 819 could be completed after each search parameter is received from the customer, after all the search parameters are received from the customer, or any combination in between.

In step 820, the IVR 115 states “If you know the road you were on when you saw the ad, please provide it now.” In step 822, an inquiry is conducted to determine if a road was received by the IVR 115. The road name can include the name of the street or the state or federal number designation for the road, such as Interstate-75. If a road was received at the IVR 115, the “Yes” branch is followed to step 824 where the IVR 115 passes the name of the road to the processor 110 for storage in the ad database 125 with the other search parameters. In step 819, a search is conducted to determine if any ads match the search parameters provided by the customer. If a road name was not received in step 822, the “No” branch is followed to step 826.

In step 826, the IVR 115 states “If you know the direction you were driving when you saw the ad, please provide it now.” In step 828, an inquiry is conducted to determine if a direction was received by the IVR 115 from the customer. A direction can include north, south, east, west, any combinations therein or directions toward or away from a landmark. Typically billboards are constructed so as to be viewed more easily when traveling in one direction on a road as compared to driving the other direction. If a direction was received at the IVR 115, the “Yes” branch is followed to step 830 where the IVR 115 passes the direction to the processor 110 for storage in the ad database 125. In step 819, a search is conducted to determine if any ads match the search parameters provided by the customer. If a direction was not received in step 828, the “No” branch is followed to step 832.

In step 832, the IVR 115 states “If you recall the side of the road the billboard was on, please provide it now.” In step 834, an inquiry is conducted to determine if a side was received by the IVR 115. The side typically includes the left or the right, but can include information embedded into or suspended above the roadway. If a side was received at the IVR 115, the “Yes” branch is followed to step 836 where the IVR 115 passes the side to the processor 110 for storage in the ad database 125 with the other search parameters. In step 819, a search is conducted to determine if any ads match the search parameters provided by the customer. If a side was not received in step 834, the “No” branch is followed to step 838.

In step 838, the IVR 115 states “If you can describe the features or words of the billboard, please do so now.” Billboard features can include the color of the billboard, the background of the ad on the billboard, whether the ad was two or three-dimensional, or the pictures or caricatures on the billboard. In step 840, the IVR 115 passes the features or words provided by the customer to the processor 110 for storage in the ad database 125. The features or words provided by the customer can be provided one-at-a-time with prompts by the IVR 115 or can be provided all at once by the customer, with the IVR 115 having the capability to parse the different words and features being described by the customer. In step 819, a search is conducted to determine if any ads match the search parameters provided by the customer.

In step 842 an inquiry is conducted to determine if there are any other search parameters that the IVR 115 should request from the customer. If not, the “No” branch is followed to step 848. Otherwise, the “Yes” branch is followed to step 844, where the IVR 115 makes a request to the customer via the telephone 130 for information related to the additional search parameters. In step 846, the additional requested information received from the customer is added to the search parameters in the ad database 125. In step 819, a search is conducted to determine if any ads match the search parameters provided by the customer. In step 848, the IVR 115 transmits a message to the customer stating “We are sorry that we were unable to find the billboard ad you were searching for. Please try again later.” The process then continues to the END step.

FIG. 9 is a logical flowchart diagram presented to illustrate the steps of an exemplary process 584 for providing post-match options to a customer, within the operating environment of the exemplary ad information system 100 of FIG. 1. Referencing FIGS. 1, 5A, and 9, the exemplary method 584 begins at step 582 of FIG. 5A and follows the “Yes” branch to step 905, where the IVR 115 asks “Would you like to be connected to the seller for Y” If so, the “Yes” branch is followed to step 910, where the processor 110 retrieves the contact information for the Y ad and connects the customer to the seller for the product offered in the Y ad. In step 915, the memory portal 105 charges a connection fee to the seller for the product offered in the Y ad. The process then continues to the END step. Returning to step 905, if the customer does not want to be connected, the “No” branch is followed to step 920.

In step 920, the IVR 115 inquires “Would you like more information about Y?” If the customer signals that they do not want additional information, the “No” branch is followed to step 935 where the IVR 115 states “We are sorry that we were unable to find the ad you were searching for, please try again later.” Otherwise, the “Yes” branch is followed to step 925, where additional information about Y can be retrieved by the processor 110. The processor 110 provides the additional information about Y to the customer via the telephone 130 in step 930. The information could be in the form of a .WAV or other audio file, video or text imaging files, or could be transmitted to the customer using the IVR 115. The process then continues to the END step.

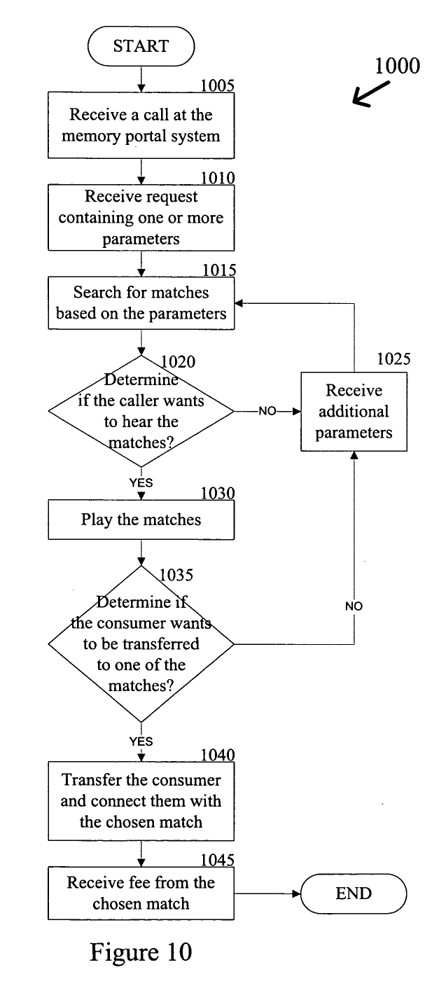

FIG. 10 is a logical flowchart diagram illustrating an exemplary method 1000 for a consumer accessing the memory portal system and accessing information stored in the system, within the operating environment of the exemplary ad information system 100 of FIG. 1. Now referring to FIGS. 1 and 10, the exemplary method 1000 begins at the START step and proceeds to step 1005, where a call is received at the memory portal 105 from the phone 130. In step 1010, the IVR 115 receives a request from a consumer on the telephone 130 for information about a company or type of business for which the consumer is looking for provides one or more parameters for the memory portal 105 to use in a search. For example, a consumer may be looking for a steak restaurant in Tampa, Fla. The consumer could call the memory portal system 105 and provide the search parameters steak, restaurant and Tampa, even without the consumer having seen or recalled a commercial about a steak restaurant. Thus, the memory portal system also can act as a telephonic yellow pages, capable of receiving a set of search parameters and providing potential matches to a caller to the memory portal 105.

In step 1015, the memory portal 105 searches for matches to the parameters provided by the consumer in the ad database 125. Those of ordinary skill in the art will recognize that the ad database 125 is not limited to ad information but also can include information about businesses and retailers that have not placed ads or stored ads in the memory portal system 105. Thus, like a yellow pages, the database 125 can contain some businesses who take out ad space and others that only provide listing information. These businesses also can provide keywords or descriptions that can be used for searches, or that information can be provided by the memory portal system 105.

In step 1020, an inquiry is conducted to determine if the caller wants to hear the matches located by the memory portal system 105. If not, the “NO” branch is followed to step 1025, where the IVR 115 requests additional search parameters, like those described in FIGS. 5-9, from the caller. The process then returns to step 1025. On the other hand, if the caller wants to hear the matches, the “YES” branch is followed to step 1030, where the IVR 115 plays the matches. The matches can be ads provided by the businesses that matched the search parameters, or the matches can be a listing of the businesses that matched the search parameters. Furthermore, the order of the listing of businesses or ads can be controlled by the memory portal system 105. For example, a business can provide additional monetary funding to the operators of the memory portal system 105 so that their business is listed first in a listing of potential matches to a caller. Businesses also can provide additional monetary funding to select another position in the order of businesses listed or ads played to a consumer. In addition, a business can provide additional monetary funding to ensure that its business is listed when one or more parameters is provided by a caller to the memory portal system 105.

In step 1035, an inquiry is conducted to determine if the consumer wants to be transferred to one of the matches. If not, the “NO” branch is followed to step 1025, where the IVR 115 requests that the caller provide additional search parameters to the memory portal system 105. Otherwise, the “YES” branch is followed to step 1040, where the memory portal system 105 calls the selected business and transfers the caller to the business. In step 1045, the memory portal system 105 charges the selected business and receives a monetary fee from that business for transferring the caller to it. The process continues to the END step.

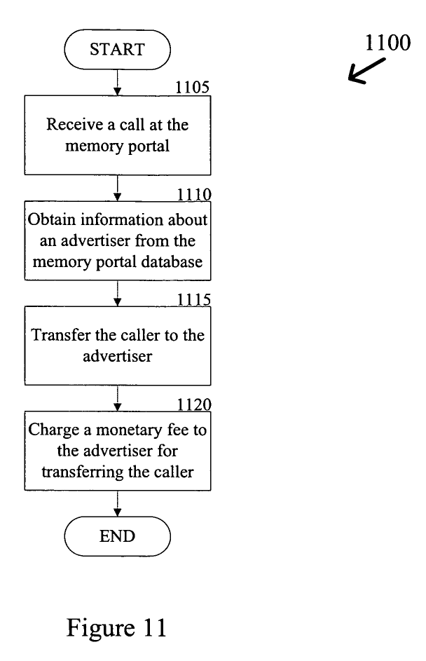

FIG. 11 is a logical flowchart diagram presented to illustrate an exemplary method 1100 for charging an advertiser or member on the memory portal system a fee for transferring calls to the advertiser, within the operating environment of the exemplary ad information system 100 of FIG. 1. Now referring to FIGS. 1 and 11, the exemplary method 1100 begins at the START step and proceeds to step 1105, where a call is received from a caller via the phone 130 at the memory portal system 105. In step 1110, the memory portal system 105 obtains information about a business or an advertiser from the memory portal system 105 in a manner substantially similar to the methods described in FIGS. 5-10 herein. The memory portal system 105 transfers the caller to a selected advertiser or business listed in the ad database 125 in step 1115. In step 1120, the memory portal system 105 charges the selected business and receives a monetary fee from that business for transferring the caller to it. The process continues to the END step.

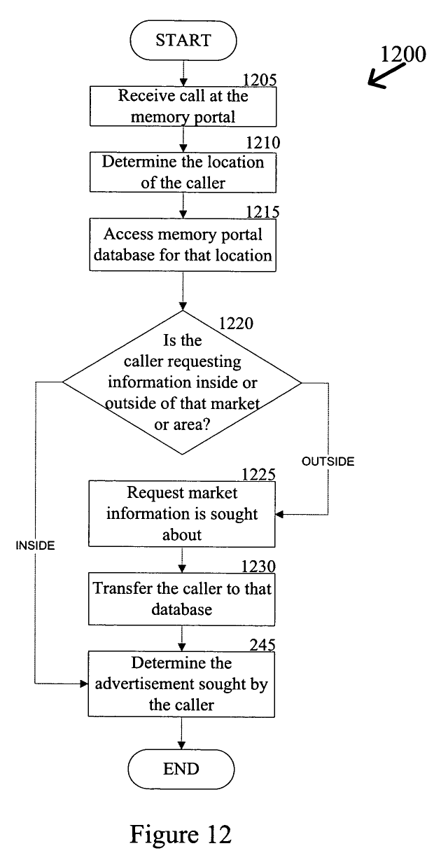

FIG. 12 is a logical flowchart diagram presented to illustrate the general steps of an exemplary process 1200 for accessing one of multiple memory portals or ad databases based on the location of the caller, within the operating environment of the exemplary ad information system 100 of FIG. 1. Now referring to FIGS. 1 and 12, the exemplary method 1200 begins at the START step and proceeds to step 1205, where the memory portal 105 receives a call from a caller via the phone 130. In step 1210, the memory portal 105 determines the location of the caller. The location can be based on the area code from which the call was made, the zip code from which the call was made, or the area code or zip code of the cell tower from which a call was made on a cellular phone.

The memory portal 105 transfers or assigns the call to the memory portal 105 or ad database 125 associated with the location from which the call originated in step 1215. In one exemplary embodiment, the exemplary system 100 can be made up of many memory portal systems 105, each assigned a particular area. In another exemplary embodiment, the exemplary system 100 can include one or more memory portal systems 105, each having multiple ad databases 125, wherein each ad database 125 is assigned to a particular area or locale. In step 1220, the memory portal database 105 determines if the caller is requesting information from inside or outside of the area or market from which the caller is calling. In one exemplary embodiment, the IVR 115 can ask the caller if they are seeking information from a business outside of the calling area and present the caller with the limitations of the calling area.

If the caller wants information about a business outside of the calling area, the “OUTSIDE” branch is followed to step 1225, where the IVR 115 requests information about the area or market from which the caller wants information. The information can include a zip code, area code, city name, state name, metropolitan area description or other geographically based information. In step 1230, the memory portal 105 transfers the caller to the memory portal 105 or database 125 associated with the requested area. The process then proceeds to step 245. Returning to step 1220, if the caller wants information from the location from which he/she is calling, the “INSIDE” branch is followed to step 245, where the memory portal system determines the information sought by the caller in a manner the same or substantially similar to the exemplary methods taught in FIGS. 5-11 herein. The process continues to the END step.

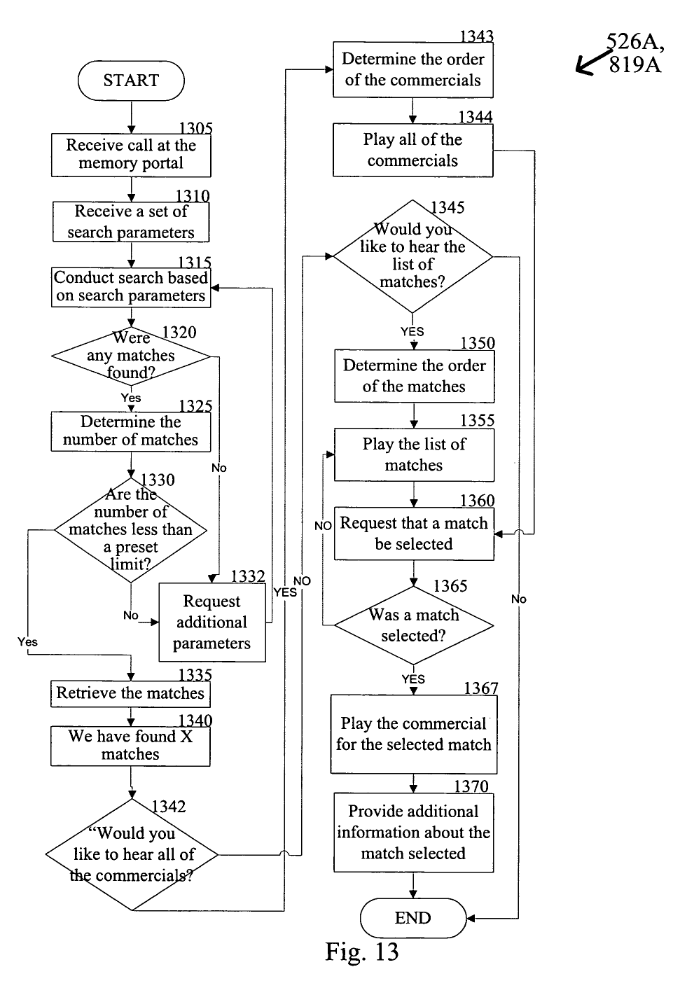

FIG. 13 is a logical flowchart diagram presented to illustrate the steps of an exemplary process 1300 presenting a listing of businesses or members in the ad database 125 that match one or more parameters provided to the memory portal system 105, within the operating environment of the exemplary ad information system 100 of FIG. 1. Now referring to FIGS. 1 and 13, the exemplary method 1300 begins at the START step and proceeds to step 1305, where a call is received at the memory portal 105 from the phone 130. In step 1310, the processor 110 retrieves the search parameters provided by the customer from the ad database 125. The processor conducts a search of the ads in the ad database 125 based on the search parameters in step 1315.

In step 1320, an inquiry is conducted to determine if any ads matched the search parameters. An ad could match the search parameters if it matches all or some of the search parameters depending on the sensitivity of the search. If no ads in the ad database 125 matched the search parameters, the “No” branch is followed to step 1332 where the IVR 115 requests additional search parameters from the caller. The process then returns to step 1315. The search conducted in step 1315 can be conducted after each new search parameter is received from a customer, intermittently as search parameters are received from a customer, after all the search parameters are received from a customer, or may only begin after a certain number of search parameters are received from a customer. If ads matching the search parameters were found in the ad database 125, the “Yes” branch is followed to step 1325.

The processor 110 determines the number of matches in step 1325. In step 1330, an inquiry is conducted to determine if the number of matches is less than a preset limit. A preset limit will typically be introduced to restrict the system from providing a customer with so many matches that they would not want to wade through all of the matches to find the ad for which they are searching. In one exemplary embodiment, the preset limit is six, so that the memory portal 105 will only provide the matches to the customer via the telephone 130 if there are five or fewer matches. If the number of matches is not less than the preset limit, the “No” branch is followed to step 1332. Otherwise, the “Yes” branch is followed to step 1335, where the processor 110 retrieves a list of businesses that match the search parameters, or have ads that match the search parameters, from the ad database 125.

In step 1340, the IVR 115 states to the customer “We have found X matches,” with X representing the number of businesses that matched, or have ads that matched the search parameters. In step 1342, the IVR 115 asks the customer “would you like to hear all of the commercials?” If so, the “YES” branch is followed to step 1343, where the processor 110 determines the order in which the commercials will be played to the consumer. Those of ordinary skill in the art will recognize that the order in which the business names or ads are played can include, but is not limited to, alphabetical order, order of highest probability of a match, order in which the matches were located in the database, random order, ordered by distance from the caller, popularity based on the number of presentations or selections of the name or ad, and other suitable order methods. In one exemplary embodiment, a business can provide additional monetary funding to the operators of the memory portal system 105 so that their business is listed first in a listing of potential matches to a caller or their ad is played first to a caller. Businesses also can provide additional monetary funding to select another position in the order of businesses listed or ads played to a consumer. In addition, a business can provide additional monetary funding to ensure that its business is listed when one or more parameters is provided by a caller to the memory portal system 105. In step 1344, the IVR 115 retrieves all of the commercials from the ad database 125 and plays them to the customer. The process then continues to step 1360.

Returning to step 1342, if the customer indicates that they do not want to hear all of the commercials, the “NO” branch is followed to step 1345. In step 1345, the IVR 115 inquires “Would you like to hear the matches?” If the customer does not want to hear the matches, the “No” branch is followed to the END step. If the customer signals that they would like to hear the matches, the “Yes” branch is followed to step 1350, where the memory portal 105 determines the order in which to play the matched businesses and/or ads. The ordering process can be the same or different from that described above in step 1343.

The list of matches is played by the IVR 115 in step 1355. In one exemplary embodiment, the matches are played such that the name of a business is played and then a number, such as one, then another business name and another number, such as two, until all of the matching businesses have been played. The caller can then select a match by pressing a number or speaking the number corresponding to the business name on their telephone 130. In step 1360, the IVR 115 requests that a match be selected. In step 1365, an inquiry is conducted to determine if a match was selected by the caller. If not, the “NO” branch is followed back to step 1355. Otherwise, the “YES” branch is followed to step 1367, where the IVR 115 retrieves the advertisement for the selected match from the ad database 125 and plays the ad for the customer. In step 1370, the memory portal system 105 provides additional information about the selected match or connects the caller with the business selected. The process continues to the END step.

In conclusion, the present invention supports a method for providing a single point of access for information about advertisements from a multitude of sellers. Furthermore, the present invention supports a method for creating a telephonic connection between a consumer who has viewed an advertisement and a seller of the product associated with the advertisement. The present invention further supports a method for retrieving advertisements for products similar to the products sought by a consumer accessing the memory portal system and playing advertisements associated with those similar products. The present invention further supports a method for locating contact information for sellers that do not provide ad information to the memory portal system and creating a telephonic connection between the consumer and that seller for a fee that is charged to the consumer. It will be appreciated that the present invention fulfills the needs of the prior art described herein and meets the above-stated objectives. While there have been shown and described several exemplary embodiments of the present invention, it will be evident to those skilled in the art that various modifications and changes can be made thereto without departing from the spirit and the scope of the present invention as set forth in the appended claims and equivalence thereof. In particular, those of ordinary skill in the art will recognize that the order of requesting, retrieving parameters and the types or parameters requested are variable and can the orders of retrieving and the types of parameters requested and retrieved can be modified without departing from the scope of this invention. Furthermore, the timing and method for searching for a match to an ad or business based on the search parameters is also variable and modifying the timing or how the parameters are used in the search can be modified without departing from the scope of this invention.

I claim:

1. A method of providing a single point of access for information about distinct products and services in a multitude of distinguishable advertisements, comprising the steps of:
providing an advertisement comprising a reference indicating information about the advertisement is available on an ad retrieval system;
receiving a telephonic request for information about the advertisement at the ad retrieval system;
determining the advertisement a user is requesting information about; and
providing information about the advertisement to the user.

2. The ad retrieval method of claim 1, further comprising the steps of:
receiving a first set of information about the advertisement at the ad retrieval system, wherein the first set of information comprises a copy of the advertisement, a location where the ad will be provided, a product or service being offered in the advertisement and contact information for a seller of the product or service being offered in the advertisement; and
storing the first set of information about the advertisement in the ad retrieval system.

3. The ad retrieval method of claim 2, further comprising the steps of:
generating a time stamp for the advertisement on each occasion that the advertisement is broadcast;
receiving the time stamp for the advertisement at the ad retrieval system; and
storing the time stamp with the first set of information about the advertisement in the ad retrieval system.

4. The ad retrieval method of claim 2, further comprising:
providing a first set of voice prompts to request additional information about the advertisement;
receiving at least one response to the first set of voice prompts from a supplier of the first set of information about the advertisement; and
storing the response with the first set of information about the advertisement in the ad retrieval system.

5. The ad retrieval method of claim 1, wherein the step of determining the advertisement the user is requesting information about further comprises the steps of:
providing a second set of voice prompts requesting information about the advertisement;
determining if a response was received from the user to the second set of voice prompts;
adding the response to a set of search parameters if the response to the second set of voice prompts was received from the user;
searching an advertisement database for the requested advertisement based on the set of search parameters; and
determining if at least one advertisement in the advertisement database matches the set of search parameters.

6. The ad retrieval method of claim 5, further comprising the steps of:
receiving a name of a seller from the user in response to the second set of voice prompts;
determining if the seller provides information about the seller's advertisements to the ad retrieval system;
determining contact information for the seller if the seller does not provide information about the seller's advertisements to the ad retrieval system;
providing a third set of voice prompts to determine if the user wants to be connected to the seller in exchange for a monetary fee;
connecting the user to the seller if the user wants to be connected; and
charging a monetary fee to the user.

7. The ad retrieval method of claim 6, further comprising the step of sending the seller a message that a search was made for the seller's advertisements on the ad retrieval system.

8. The ad retrieval method of claim 5, further comprising the steps of:
a. determining at least one closest matching advertisement to the set of search parameters if no advertisements match all of the set of search parameters;
b. retrieving the closest matching advertisements from the ad database;
c. providing a fourth set of voice prompts to determine if the user wants to listen to the closest matching advertisements;
d. playing a first closest matching advertisement if the user wants to listen to the closest matching advertisements;
e. determining if the first closest matching advertisement is the advertisement the user was searching for;
f. repeating steps (d)-(e) for each additional closest matching advertisement if the first closest matching advertisement is not the advertisement the user was searching for;
g. retrieving the contact information for a seller associated with the first closest matching advertisement if the first closest matching advertisement is the advertisement the user was searching for; and
h. connecting the user to the seller associated with the first closest matching advertisement.

9. The ad retrieval method of claim 8, wherein the order of playing the matching advertisements is modified when a business pays a monetary fee to have its advertisement played in a selected position in the order of matching advertisements.

10. The ad retrieval method of claim 5, further comprising the steps of:
a. receiving a name of a seller from the user in response to the second set of voice prompts;
b. receiving a product type from the user in response to the second set of voice prompts;
c. determining if the seller provides information about the seller's advertisements to the ad retrieval system;
d. determining at least one other seller of the product type that provides information about advertisements to the ad retrieval system if the seller does not provide information about the seller's advertisements to the ad retrieval system;
e. playing the advertisement of the other seller of the product type;
f. determining if the user wants to be connected to the other seller of the product type;
g. repeating steps (d)-(f) if the user does not want to be connected to the other seller; and
h. generating a telephonic connection between the user and the other seller if the user wants to be connected.

11. The ad retrieval method of claim 10, wherein a business can pay a monetary fee to be selected as one of the other sellers of the product type and have its advertisement played to the user.

12. The ad retrieval method of claim 1, wherein the step of providing information about the advertisement further comprises the steps of:
determining if the user wants to listen to a reproduction of the advertisement the user is requesting information about;
playing a reproduction of the advertisement if the user wants to listen;
determining if the user would wants to be telephonically connected to a seller associated with the advertisement;
retrieving contact information for the seller associated with the advertisement if the user wants to be telephonically connected to the seller; and
generating a telephonic connection between the user and the seller of the advertisement.

13. The ad retrieval method of claim 12, further comprising the step of charging a monetary fee to the seller of the advertisement in response to generating the telephonic connection.

14. The ad retrieval method of claim 12, further comprising the steps of:
determining if the user would like to receive additional information associated with the advertisement the user is requesting information about;
retrieving the additional information from the information about the advertisement in the ad database if the user would like the additional information; and
providing the additional information to the user.

15. The ad retrieval method of claim 1, wherein the reference indicating information about the advertisement is available on the ad retrieval system is a telephone number.

16. The ad retrieval method of claim 1, wherein the reference indicating information about the advertisement is available on the ad retrieval system is a symbolic representation of the ad retrieval system.

17. The ad retrieval method of claim 1, wherein the reference indicating information about the advertisement is available on the ad retrieval system is at least one auditory tone.

18. The ad retrieval method of claim 1, wherein the reference indicating information about the advertisement is available on the ad retrieval system is at least one word.

19. The ad retrieval method of claim 1, wherein the advertisement is a radio advertisement.

20. The ad retrieval method of claim 1, wherein the advertisement is a billboard advertisement.

21. The ad retrieval method of claim 1, wherein the advertisement is a television advertisement.

22. A method of providing an ad retrieval system as a single point of access for information about products and services in a multitude of distinguishable advertisements from disparate sellers, comprising the steps of:
receiving a first set of information about a billboard advertisement at the ad retrieval system, wherein the first set of information comprises the location of the billboard advertisement; a product being offered in the billboard advertisement; a script of the billboard advertisement, and contact information for a seller associated with the billboard advertisement;
displaying the billboard advertisement comprising a reference indicating information about the billboard advertisement is available on the ad retrieval system;
receiving a telephonic request from a user for information about the billboard advertisement at the ad retrieval system;
providing a first set of voice prompts requesting information from the user about the billboard advertisement;
generating a set of search parameters comprising at least one response from the user to the first set of voice prompts;
searching an ad database based on the set of search parameters to locate the first set of information for the billboard advertisement the user is searching for; and
generating a telephonic connection between the user and the seller associated with the billboard advertisement.

23. The ad retrieval method of claim 22, further comprising the steps of:
determining if the user would like to receive additional information associated with the billboard advertisement;
retrieving the additional information from the information about the billboard advertisement; and
providing the additional information to the user.

24. The ad retrieval method of claim 22, further comprising the steps of:
determining if the user want to receive a reproduction of the billboard advertisement the user is requesting information about; and
providing the reproduction of the billboard advertisement based on the determination that the user wants to receive the reproduction.

25. The ad retrieval method of claim 24, wherein the reproduction comprises an electronic visual image of the billboard advertisement transmitted to the user.

26. The ad retrieval method of claim 24, wherein the reproduction comprises and auditory reproduction of the script of the billboard advertisement.

27. The ad retrieval method of claim 22, further comprising the steps of
receiving a name of a seller associated with the billboard advertisement from the user in response to the first set of voice prompts;
determining if the seller provides information about the seller's advertisements to the ad retrieval system;
determining contact information for the seller if the seller does not provide information about the seller's advertisements to the ad retrieval system;
determining if the user wants to be connected to the seller; and
generating a telephonic connection between the user and the seller associated with the billboard advertisement.

28. The ad retrieval method of claim 22, further comprising the steps of:
searching the ad database for at least one closest matching advertisement to the set of search parameters if no billboard advertisements match all of the set of search parameters, wherein the search of the ad database comprises a search of all advertisements in the ad database;
retrieving the closest matching advertisements from the ad database;
determining if the user wants to listen to the closest matching advertisements;
playing a first closest matching advertisement if the user wants to listen to the closest matching advertisements;
determining if the first closest matching advertisement is the advertisement the user was searching for;
retrieving the contact information for a seller associated with the first closest matching advertisement if the first closest matching advertisement is the advertisement the user was searching for; and
generating a telephonic connection between the user and the seller associated with the first closest matching advertisement.

29. The ad retrieval method of claim 28, wherein the order of playing the matching advertisements is modified when a business pays a monetary fee to have its advertisement played in a selected position in the order of matching advertisements.

30. The ad retrieval method of claim 22, further comprising the steps of:
a. receiving a product type from the user in response to the first set of voice prompts;
b. determining if the ad database comprises the first set of information for the billboard advertisement the user is searching for;
c. determining at least one other seller associated with the product type that provides information about advertisements to the ad retrieval system if the first set of information for the billboard advertisement the user is searching for is not in the ad database;
d. playing the advertisement of the other seller of the product type;
e. determining if the user wants to be connected to the other seller of the product type;
f. repeating steps (c)-(e) if the user does not want to be connected to the other seller; and
g. generating a telephonic connection between the user and the other seller if the user wants to be connected.

31. The ad retrieval method of claim 30, wherein a business can pay a monetary fee to be selected as one of the other sellers of the product type and have its advertisement played to the user.

32. The ad retrieval method of claim 22, wherein the reference indicating information about the billboard advertisement is available on the ad retrieval system is a telephone number.

33. The ad retrieval method of claim 22, wherein the reference indicating information about the billboard advertisement is available on the ad retrieval system is a symbolic representation of the ad retrieval system.

34. The ad retrieval method of claim 22, wherein the reference indicating information about the advertisement is available on the ad retrieval system is at least one word.

35. A method of providing a single point of access for information about distinct products and services in a multitude of distinguishable advertisements from disparate sellers, comprising the steps of:
receiving a telephonic request from a user for information about a product associated with an advertisement at an ad retrieval system;
providing a first set of voice prompts requesting information about the advertisement from the user;
adding at least one response from the user to the first set of voice prompts to a set of search parameters;
searching an ad database based on the set of search parameters to locate the information about the product associated with the advertisement;
determining if at least one advertisement in the ad database matches the set of search parameters;
playing a reproduction of the advertisement that matches the set of search parameters; and
generating a telephonic connection between the user and a seller associated with the advertisement.

36. The ad retrieval method of claim 35, further comprising the step of charging a monetary fee to the seller associated with the advertisement in response to generating the telephonic connection.

37. The ad retrieval method of claim 35, further comprising the steps of:
determining if the user would like to receive additional information associated with the product the user is requesting information about;
retrieving the additional information from the ad database if the user would like the additional information; and
providing the additional information to the user.

38. The ad retrieval method of claim 35, further comprising the step of providing an advertisement comprising a reference indicating information about the advertisement is available at the ad retrieval system.

39. The ad retrieval method of claim 35, further comprising the steps of:
receiving a first set of information about the advertisement at the ad retrieval system;
generating a time stamp for the advertisement on each occasion that the advertisement is broadcast;
receiving the time stamp for the advertisement at the ad retrieval system; and
storing the time stamp with the first set of information about the advertisement in the ad database.

40. The ad retrieval method of claim 35, further comprising the steps of:
receiving a name of a seller associated with the product the user wants information about from the user in response to the first set of voice prompts;
determining if the seller provides information about advertisements associated with the seller to the ad retrieval system;
determining contact information for the seller if the seller does not provide information about advertisements associated with the seller to the ad retrieval system;
determining if the user wants to be connected to the seller in exchange for a monetary fee;
connecting the user to the seller if the user wants to be connected;
charging a monetary fee to the user; and
sending the seller a message that a search was made for the seller's advertisements on the ad retrieval system.

41. The ad retrieval method of claim 35, further comprising the steps of:
a. determining a product type from the user's responses to the first set of voice prompts;
b. searching the ad database for at least one other seller associated with the product type that provides information about advertisements to the ad retrieval system;
c. determining if the user wants to hear an advertisement for the other sellers associated with the product type;
d. playing the advertisement of the other seller of the product type;
e. determining if the user wants to be connected to the other seller of the product type;
f. repeating steps (c)-(e) if the user does not want to be connected to the other seller; and
g. generating a telephonic connection between the user and the other seller if the user wants to be connected.

42. The ad retrieval method of claim 41, wherein a business can pay a monetary fee to be selected as one of the other sellers of the product type and have its advertisement played to the user.

43. A method of providing a single point of access for information about a multitude of distinguishable advertisements from disparate sellers, comprising the steps of:
generating a plurality of advertisements from a plurality of disparate sellers comprising a reference indicating information about each advertisement is available from a single source; and
providing telephonic access to the single source to obtain information about each advertisement.

44. The ad retrieval method of claim 43, wherein the reference indicating information about the advertisement is available from a single source is a telephone number.

45. The ad retrieval method of claim 43, wherein the reference indicating information about the advertisement is available from a single source is a symbolic representation of the ad retrieval system.

46. The ad retrieval method of claim 43, wherein the reference indicating information about the advertisement is available on the ad retrieval system is at least one auditory tone.

47. The ad retrieval method of claim 43, wherein the reference indicating information about the advertisement is available from a single source is at least one word.

48. A method of providing a single point of access for information about distinct products and services provided by a multitude of businesses comprising the steps of:
receiving a request for information about a business providing a product or service;
providing a first set of voice prompts requesting information about the product or service;
adding a received response to the first set of voice prompts comprising a keyword to a set of search parameters, wherein the keyword is not the name or address of a business;
searching a database for at least one business matching at least one of the set of search parameters;
determining if a user wants to hear a commercial for each of the matching businesses;
retrieving a commercial for each of the matching business based on a positive determination that the requester wants to hear a commercial for each of the matching businesses; and
playing the commercials.

49. The ad retrieval method of claim 48, further comprising the step of placing the commercials in a sequential order prior to playing.

50. The ad retrieval method of claim 49, wherein the order of playing the commercials is modified when a business pays a monetary fee to have its name played first in the list of businesses.

51. The ad retrieval method of claim 48, further comprising the steps of:
retrieving a list of matching businesses based on a negative determination that the requester wants to hear a commercial for each of the matching businesses;
placing the list of businesses in an order
playing the list of businesses;
determining if one of the business in the list of business was selected by a user; and
playing a commercial for the selected business.

52. The ad retrieval method of claim 51, wherein the order of playing the matching businesses is modified when a business pays a monetary fee to have its name played first in the list of businesses.

53. The ad retrieval method of claim 48, further comprising the steps of:
determining if a user wants additional information about at least one of the matching businesses
retrieving the contact information for the business selected by the user; and
generating a telephonic connection between the user and the selected business.

54. The ad retrieval method of claim 53, further comprising the step of charging a monetary fee to the selected business in response to generating the telephonic connection between the user and the selected business.

55. The ad retrieval method of claim 48, further comprising the steps of:
determining if the user would like to receive additional information associated with the selected business;
retrieving the additional information from the database; and
providing the additional information to the user.

56. A method of providing a single point of access for information about distinct products and services in a multitude of distinguishable advertisements, comprising the steps of:
receiving a telephonic request for information about an advertisement at a first ad retrieval system;
determining a location from which the telephonic request originated;
determining if the location is within a first region covered by a first ad retrieval system;
transferring the telephonic request to a second ad retrieval system that has a second region that the location is within if the location is not within the first region;
providing a first set of voice prompts requesting information about the advertisement;
adding a received response to the first set of voice prompts to a set of search parameters;
searching a database for at least one advertisement matching at least one of the set of search parameters;
retrieving a set of advertisements comprising at least one advertisement most closely matching the set of search parameters from the database; and
playing the set of advertisements.

57. The ad retrieval method of claim 56, further comprising the steps of:
determining if the user selected one of the set of advertisements;
determining if the user wants to be telephonically connected with a business associated with the selected advertisement if the user selected one of the set of advertisements; and
generating a telephonic connection between the user and the business associated with the selected advertisement.

58. The ad retrieval method of claim 57, further comprising the step of charging a monetary fee to the business in response to generating the telephonic connection between the user and the business.

59. The ad retrieval method of claim 56, further comprising the steps of:
determining if the user selected on of the set of advertisements;
determining if the user wants additional information about a business associated with the selected advertisement if the user selected one of the set of advertisements; and
retrieving additional information about the business from a database.
